(19) United States
(12) Patent Application Publication
(10) Pub. No.: US 2002/0016718 A1
(43) Pub. Date: Feb. 7, 2002

(54) Medical image management system and method

(76) Inventors: Peter A. Rothschild, Redwood City, CA (US); Vijendra Guru Raaj Prasad, Fremont, CA (US); William M. M. Weir, Redwood City, CA (US)

Correspondence Address: Susan M. Schmitt, P.O. Box 11339, Santa Rosa, CA, 95406, US

(21) Appl. No.: 09/871,997

(22) Filed: Jun. 1, 2001

Related U.S. Application Data
(63) Continuation-in-part of application No. 09/771,446, filed on Jan. 25, 2001.
Application No. 09/771,446 is a continuation-in-part of application No. 09/602,643, filed on Jun. 22, 2000.

(51) Int. Cl. G06F 17/60; H04L 12/56

(52) U.S. Cl. 705/2; 370/389; 707/104.1; 705/3

(57) ABSTRACT

The present invention provides a medical image management system and method that uses a central data management system to centrally manage the storage and transmission of electronic records containing medical images between remotely located facilities. The present invention also provides a system and method for packaging an image for secure transmission. The present invention also provides a system for tracking delivery and review of images and various attachments or augmentations to the image files. The invention also provides a system and method for providing lifetime storage of images that may be accessed by different authorized imaging centers and providers throughout the life of the patient. An image or file is packaged to be transmitted through a firewall of an image viewing location and stored in a relational database at the remote viewer. The image is delivered to a physician for ready accessibility at a remote viewer. Various files may be added to the patient's file at remote viewers. Overlays, reports and other attachments are created or input at image viewing stations and may packaged for delivery to authorized locations and are tracked and stored by a data center.

This application is a continuation-in-part or U.S. application Ser. No. 09/771,446, which is a continuation-in-part of U.S. application Ser. No. 09/602,643, which are incorporated herein by reference.

### TECHNICAL FIELD

The present invention is a system and method for managing medical images. More specifically, it is a computer-based system and method for capturing, transmitting, storing, processing, and communicating electronic records associated with medical images.

### BACKGROUND

Diagnostic imaging technology has evolved tremendously in the past twenty years, offering very sophisticated imaging tests such as magnetic resonance imaging (MRI) and computed tomography (CT). The MRI market in particular includes approximately 6,000 MRI machines in the United States, and 12,000 worldwide. Two-thirds of MRI devices in the US are located in clinics and small hospitals. There are over 12,000 CT scanners in the United States and over 20,000 worldwide. Other significant medical imaging markets include for example, ultrasound, nuclear medicine, digital x-ray, and computerized radiology. On the aggregate, the potential medical image management market has been estimated at $5.5 Billion annually in the US and $12 Billion worldwide.

The need for immediate electronic delivery and convenient, economic storage of radiologic and other medical images and data has never been greater. The annual United States radiology market consists of more than 150 million x-rays, 100 million sonograms, 20 million MRI scans and 30 million CT scans performed by medical practitioners. The conventional process for managing medical images at most hospitals, clinics and imaging centers is as follows. The medical image is printed onto sheets of film, which are delivered to the radiologist for interpretation. After the transcribed report is delivered to the radiologist, reviewed for errors and signed, the films and report are delivered or mailed to the referring doctor. This process often takes several days, up to a week. If questions arise, the referring doctor contacts the radiologist, who may be forced to rely upon memory, having reviewed the films several days before and no longer having possession of them. Also, the referring doctor must then manage the hard-copy films, either by filing the films in his office, or returning the films to the imaging center or hospital to be filed, depending upon practices in the local community. If the patient then goes to a second doctor, requires surgery, or requires another medical imaging procedure, the films must be located and physically carried or shipped to the hospital, surgery center, or to the second doctor's office. There are numerous opportunities for films to be lost or misfiled, and doctors who maintain more than, one office may not always have the correct patient films in the correct office.

The current film-based system is very expensive, and the charges for films, processing chemicals, and delivery can easily add up to $30 to $50 per MRI patient study. A typical MRI center scanning 300 patients per month has equivalent costs of approximately $12,000 per month ($40 per study x 300 patients/month). Other problems for the imaging facility are the numerous opportunities for the films to be physically lost, as well as the considerable time, personnel, and expense required for the delivery and retrieval of these films. Estimates are that up to 25% of medical images are not accessible when required.

Currently, most imaging centers and small hospitals store patient images on hard copy films for a limited period of time, typically ranging from 5-7 years after which the images are melted down for recovery of the silver. Theses image films are typically stored in large image libraries for this limited period of time. If the patient wants their film, a copy is made and the patient is charged. There are some imaging centers and small hospitals that have developed systems where the images are stored digitally. However, this is also for a limited time period and normally the referring physicians will not have access to this digital information. Another way that images are stored at an imaging center is on optical storage that comes from the manufacturer of the MRI or CT, etc., system. The optical storage is in a format proprietary to the manufacturer and it is difficult to obtain the information once the MRI or CT has been replaced, since it was stored under proprietary format that accompanied the previously owned CT or MRI. A client/server model of delivering images has been proposed where a provider logs on and requests live delivery of an image file stored on the client server system. Such system is undesirable in that the image delivery requires a substantial amount of time and is not available for the physician when the physician needs to review the image file. Also such systems have not been proposed for lifetime storage and access and to provide such storage and access would require the client/server have increasingly large and expensive storage capacity for live transfer. Accordingly, it would be desirable to provide a lifetime storage system that is accessible by referring physicians, patients and imaging centers to be able to retrieve previous studies over a patient's lifetime. It would also be desirable to provide a storage system that enables relatively inexpensive lifetime storage of image files while being able to deliver selected files to an authorized recipient, e.g. a patient or healthcare provider, in a manner that the files will be awaiting the recipient at the image viewer.

Currently, no widely established commercial Internet solution exists for the digital delivery and archiving of the ever-increasing vast stores of radiologic data. Many patients are accustomed to sending email with various attachments, such as files or photos, and wonder why radiology images cannot be “emailed” to their doctors. However, several barriers exist for a medical image to be “emailed” to the doctor.

In order to electronically transport medical images efficiently, the images must be in a digital format. The imaging device, such as the MRI machine, must have the computer interfacing hardware and software configured to “export” the data. A computer is needed to convert the proprietary image identification data (the header information) into a standardized format, such as DICOM (Digital Imagine, and Communication in Medicine). Also, the doctor who receives the images must have software that allows him or her to view the medical images and interpret the image header information (viewer). However, non-DICOM enabled models represent the majority of imaging machines. Due to financial constraints imposed by managed care on imaging centers, non-DICOM machines will continue to dominate diagnostic imaging for the foreseeable future.

When digital modalities such as CT and MRI first came into general clinical use, each manufacturer used its own proprietary means of reconstructing the data, formatting files and storing each of the studies. They did not share this basic information with other competing manufacturers; therefore, one set of images could not be communicated to another machine since each had a different format. In 1983, the American College of Radiology and the National Electronic Manufacturers Association met to discuss a standard. In early 1984 the two organizations formed the Digital Imaging and Communication in Medicine (DICOM) Standards Committee. After many years of extensive work, the first DICOM model was introduced in 1992. By late 1994, a few manufacturers had begun to offer to incorporate DICOM into their products, usually as an expensive ($20,000-$40,000) upgrade. However, even today, the majority of these manufacturers still today only incorporate DICOM in their new products for a significant extra charge ($20,000-$40,000). Many of the older established medical imaging systems do not even have a DICOM conversion available from the original equipment manufacturer. Whenever a DICOM conversion upgrade is available for already built and installed products, it is usually even more expensive than DICOM for a new product. DICOM is a communications standard and does not define particular hardware architecture. It permits integration of images into non-image databases and is the predominant standard for medical image communication. It enjoys broad support across specialties and other standards organizations throughout the world.

Interfaces have been developed to “DICOM enable” imaging systems that were not originally factory equipped with DICOM. Without supplying DICOM interfaces as a component of an overall system, a medical image management system in the general field contemplated by the invention would be required to take one of three courses of action: 1) limit their imaging center users to DICOM conformant equipment, 2) purchase or require their customer to purchase and install DICOM interfaces at a cost of upwards of $40,000, or 3) rely on a technique known as secondary capture. In the case of secondary capture methods, like video frame grabbing, some of the information is lost, because it only captures the 8-bit analog representation of the original 16-bit image pixel data. Also, secondary captured images cannot be later manipulated to the same degree as the original images. Because of the inherent drawbacks of secondary captured data, the American College of Radiology (ACR) standard states that the direct capture method is preferred for primary diagnosis.

It is not believed that the general imaging center and referring physician marketplace will tolerate the use of the inferior secondary capture method, or an ASP that can only connect to DICOM equipped imaging systems. The system and method of the present invention provides DICOM connectivity. Also, in order to transmit and store images without compromising the quality or integrity of the imaging data, an efficient medical image management system is preferably able to successfully connect disparate imaging equipment and systems without compromising the image quality. To accomplish this the system should be able to extract the proprietary data from various different imaging machines, again the vast majority of which are not DICOM enabled and therefore cannot “output” the data in the DICOM format. Moreover, though DICOM is the universal industry standard, like the English language different “dialects” of DICOM exist depending on how each of the many individual manufacturers “speak” the DICOM language. What this means is that it is quite common for two systems that have DICOM interfaces to still have difficulty connecting and communicating with each other. Therefore, customization of interfacing, between such machines may be required in some circumstances.

Once these above barriers are overcome, it becomes possible to electronically transmit medical images in an efficient and readily adoptable manner. These electronic images, unlike film, can be simultaneously presented in multiple locations immediately after an imaging study is performed. Picture Archiving and Communication Systems (PACS)

Various solutions have been developed with the intention of streamlining the storage and accessibility of medical images by managing, electronic records that include the images in electronic form that may be converted for viewing, such as on screen displays or via film printers.

One well-known type of such a system called “Picture Archiving and Communications Systems” (PACS) generally provides medical image management via a collection of components that enable image data acquisition, transmission, display, and, storage. Such systems are implemented in imaging clinics and hospitals to make the digital data available at different locations within the radiology department or the facility. Further, the use of such systems is generally restricted to in-house radiology and other departments, thus excluding the referring physicians, who are outside the imaging facility. These systems have high price tags ($60,000 to $ 1,000,000) for the local installation of the respective central image management and storage systems generally required, and involve other high costs related to additional personnel to configure and maintain such image management systems locally onsite at the imaging facility.

Medical Images and Internet ASP's

Because the medical image management market is so large, and represents such large volumes of recurring transmissions of electronic records associated with medical images, an ASP model for managing electronic images provides great potential for a highly profitable annuity business. Various efforts have recently been made to replace or at least significantly enhance the conventional film-based systems and methods for medical image management by managing these images electronically, and more particularly via an internet-based ASP model. However, the concept of an Internet based Application Service Provider (ASP) for the transmission and storage of medical images is an industry in its an embryonic stage. Very few, if any, of the over 300 diagnostic imaging procedures performed annually in the U.S. are being transmitted and/or stored utilizing an ASP model.

To transmit an image electronically as is intended with these known medical image management systems, the first step is to get the data from the imaging modality (CT, MR, ultrasound, etc.) to the image acquisition system at the customer site. There are two methods of obtaining this data: primary and secondary data capture. Because primary capture is not always possible in order to support other known medical image management systems and methods, they often use “secondary” or “indirect” methods. The simplest and oldest “secondary” capture method is often called “frame grabbing”. This method simply obtains the image present on the video monitor and records it. The resulting image is only 8 bits deep allowing 256 shades of gray, which means a significant amount of image data has been lost. The use of “frame grabbing” is also very labor intensive. When using “frame grabbing”, the technologists must pre-set the “window” and “level” (brightness and contrast) of the image. This requires an excessive amount of the technologist's time when compared to the more modem primary capture. These frame grabber systems work by taking the analog monitor output from a digital modality and running it through an analog-to-digital converter, which in itself degrades the data. The ability to adjust the brightness and contrast (window and level) of the image on the receiving end is also limited with images that were obtained using “secondary” capture. Measurements and position location of the image, both extremely important to the physician, are not generally possible with acceptable accuracy using secondary capture. Furthermore, due to problems described above, the latest version of the American College of Radiology (ACR) standards for teleradiology effective Jan. 1, 1999, recommends compliance to DICOM and transfer of the full image data set, which is only possible with “primary” or “direct capture” for primary diagnosis.

In general, most of the known systems and methods for managing medical images in electronic record format use “pull” type image delivery protocol which requires the referring physician to log on to a web server and then download his or her patient's images. However, busy physicians do not have the time or the desire to access their patient's images in this manner. The “pull” model requires the physician to log in as well as extensive physician input and time to initiate the data transfer. Additionally, the doctor must then wait for the image data to download.

Various more specific examples of such medical image ASP efforts are summarized in relation to respectively known companies in the general field as follows (much of the information provided immediately below is based upon information and belief, and in some cases is based only on rumor and verbal discussion—therefore the general and detailed elements for these companies may not be wholly accurate).

The following is a description of what is believed to be information related to a medical image management system to be provided by a company called “Amicas”. Amicas is a private company located in Newton, Mass. that is believed to market and sell software that allows radiology studies to be sent between Web servers. The target market for Amicas is believed to be large hospitals. It is believed that Amicas plans to enable the transfer of such images between any medical facilities that have standard e-mail systems, using UPS Document Exchange (SM)—an encryption-based secure delivery service featuring optional password protection, real-time racking and delivery confirmation. The physician still must login to get his or her email, and wait for the images to download. The company is currently using the service at 4 beta sites. The Company gained FDA approval in 1997. To qualify as a potential customer a client's machines must have DICOM installed. CEO Dr. Adrian Gropper stated in an interview conducted May 2, 2000 at the E-Healthcare Conference in Las Vegas, Nev. that Amicas has no plans to develop custom DICOM interfaces. Dr. Gropper has also stated that his company has no plans to offer any form of off site storage. It is further believed that the company uses lossy compression of the electronic records associated with medical images they manage. It is believed that Amicas has a test site which is located at the Loma Linda Veterans Administration Hospital.

The following is a description of what is believed to be information related to a medical image management system to be provided by a company called “eMed”. EMed is a private company located in Lexington, Mass. The target users are hospitals. The eMed.net service is believed to include a medical image viewing application with integrated access to medical images and reports along with other relevant information through a physician's web site. eMed Technologies is a Healthcare Application Service Provider (HASP) and takes care of everything from server hardware, domain name registration, site creation and current content, all for a monthly subscription fee of $2,500. The company has FDA approval. The company prefers DICOM equipped machines, but is able to capture images from non-DICOM imaging machines in two ways: (1) DICOM converting device at a customer cost of up to $40,000; and (2) frame grabbing—a form of secondary capture which is believed to be unacceptable for primary diagnostic interpretation.

The following is a description of what is believed to be information related to a medical image management system to be provided by General Electric Medical Systems, Dallas, Tex. and Waukesha, Wis. stated in a press release dated Apr. 9, 2000 that GE will use an ASP model to primarily store data generated at an off-site location. It is believed that this recent announcement addresses an ASP model for GE's traditional PACS system. The press release claims that GE will pilot the program during the summer of 2000. The press release does not mention numerous details (such as connectivity to their system i.e. whether non-DICOM compliant machines will ever be offered the service; whether only GE or non-GE equipment will be targeted; whether GE plans to develop any DICOM interfaces to non-DICOM equipment; what data specifically is planned to be stored). The press release mentions a network subscription fee arrangement but does not give any pricing details. Most importantly, GE does not deliver the images, but instead has the doctors log on.

The following is a description of what is believed to be information related to a medical image management system to be provided by Image Medical, a private company located in Palo Alto, California. The target market is large institutions. Image Medical uses an ASP model to transmit medical images over the Internet. The Image Medical system is called “Practice Builder”. It is DICOM compliant and works with existing PACS and provides the ability to access images and reports anywhere. “Practice Builder” includes a “Viewer” for digital medical images, CT, MR, US, DR, CR and NM. The revenue model is an activation fee that covers connectivity, infrastructure and installation costs. A per transaction fee is then charged for image acquisitions, distributions and archival. The company is not developing interfaces for imaging machines that are not DICOM equipped.

The following is a description of what is believed to be information related to a medical image management system to be provided by a company called “Inphact”, a private company located in Nashville Tenn. Inphact claims to integrate an Internet based ASP PACS with a RIS. The target market is any hospital or clinic that is unable to afford an in-house PACS. RadWeb™ allows physicians to query radiology images 24/7 via the Internet. The company plans to extend its technology platform in the future to cardiology. The company is not believed to offer push technology, image history record system, or custom DICOM interfaces.

The following is a description of what is believed to be information related to a medical image management system to be provided by In Site One, Inc. which is located in Wallingford, Conn. The primary target market is hospitals. In Site One is a service provider offering digital image storage and archiving for the medical community. For this company, the imaging device must be DICOM compliant. “In Dex” (Internet DICOM Express) is a transaction, pay as you go service for storage and archiving of DICOM images for hospitals. In Dex's open architecture integrates with any PACS component as well as hospital networks and information systems. Images can be accessed via the Internet or through virtual private networks to a hospital's network. In Dex is suited for facilities with or without PACS capabilities. For PACS owners, In Dex enables them to outsource the storage and archiving component. For non-PACS equipped facilities, In Dex delivers storage and archival of a PACS without the high capital outlay, maintenance costs, technical upgrades and staffing support. There is no delivery of images to referring physicians nor do referring physicians have access to view the images they order.

The following is a description of what is believed to be information related to a medical image management system to be provided by Radiology.com, which is located in Los Angeles, Calif. and Chantilly, Va. The target market is hospitals. Radiology.com announced the launch of a service that allows digitized medical images to be stored and retrieved on-line through a central, web-based repository on Mar. 9, 2000. The technology combines DICOM and JAVA that allows a high level of compression and encryption of medical images for transmission to a PC. The system employs an ASP model. The company claims open standards will allow lifetime access to a global central repository of medical images, named “Image Bank”. Patients can build their own imaging history through “Patient's Bank” which can be used to obtain discrete second opinions. The revenue model is a pay-as-needed approach. It is believed that this system only exists on paper and no clinical sites have been developed.

The following is a description of what is believed to be information related to a medical image management system to be provided by “Real Time Image”, a private company located in San Mateo, Calif. The target market is large hospitals with PACS. PACS on Demand is a product that allows physicians to view images anywhere, anytime, even over dial-up connections. iPACS is a Web server that integrates to PACS, allowing physicians to view images directly from a DICOM archive over the Internet using Microsoft's Internet Explorer™ or Netscape Navigator™ Web-browsers. The user must install plug-in to his or her browser before attempting any use of this product. iPACS “streams” images on the fly using original image data without pre-processing or requiring separate archives.

The following is a description of what is believed to be information related to a medical image management system to be provided by “Stentor”, a company located in the Silicon Valley. The target market is hospitals with existing Intranets. The Stentor system is PC based. Stentor's “iSYNTAX” technology delivers images only over existing hospital networks. Stentor has FDA approval. Stentor claims its iSYNTAX system will integrate into any existing hospital network. Stentor can send real time images on as slow as a 1 megabyte per second network connection. Images are encoded using a wavelet technology. A lossless representation of the transmitted image is claimed; however, lossless transmission (as the present invention performs) is not claimed. Stentor claims no bills will be sent until real savings by the imaging department have been demonstrated. Stentor charges on a per use basis.

None of the other known electronic image management sytems and methods intended to provide an ASP model adequately address the needs of referring physicians and other parties in the healthcare provider stream outside of the imaging clinic.

In one regard, other systems intending to provide a medical image ASP service generally require timely log-on and download procedures at the physician terminal. In another regard, none of the other systems and methods intended to provide a medical image ASP are believed to provide the image center with a history record of where and when images are sent, received, and viewed. However, a system which pushes the images directly to remotely located desktops of interested healthcare providers or patients outside of the imaging clinic would be much more resource efficient at their end. Furthermore, medical imaging centers producing the electronic images would benefit from a system which provides them with a real-time, image history record with easily accessible information about the times and places that each image is sent, received, and viewed at all locations.

Also, other efforts intended to provide a cost-effective ASP generally require costly hardware investment, principally on the part of the respective imaging center, and according to some of these efforts per-use fees are charged for each image viewing occasion. However, smaller imaging clinics and healthcare providers outside of the imaging center would benefit from a business model which provides the associated image work-stations necessary to use the ASP without requiring capital expenditure on the hardware or software. These parties would be greatly benefited by a method that provides a medical image ASP on a monthly service fee only basis, without up-front hardware costs, and without costly “per-use” transaction fees. Moreover, by providing a medical image ASP that charges only the imaging clinics on a fixed fee basis, these centers would be able to solely enjoy the economic benefits of their increased revenues flowing from increased image volume, at least to the extent that such volume is charged through to payers. In particular, the imaging center would benefit from an electronic medical image ASP system that charges only fixed or per use fees, but that provides without direct capital expenditure a local image workstation at the imaging center (including in one aspect a DICOM conversion interface) for interfacing with the remotely located, central management system of the ASP. Other interested healthcare providers and patients outside of the imaging clinic would also greatly benefit from having access to a remote image viewing system for viewing and storing the electronic images available from the ASP, but without requiring them or the imaging center to pay for the viewing system.

### SUMMARY OF THE INVENTION

The present invention provides a medical image management system and method that reduces the high financial cost, resource allocation, time, and unreliability associated with conventional production, transportation, and viewing of conventional film-based systems and methods.

The invention in another regard also provides a medical image management system and method that reduces the need for purchasing and/or managing sophisticated technology at medical imaging centers.

The invention also provides a medical image management system that directly addresses the needs of the referring physicians and other healthcare providers located outside of the imaging center and having interest in medical image studies.

The invention also provides a medical image management system and method that integrates diagnostic and other analytical software, algorithms, or other tools associated with medical images within one, central medical image management ASP.

The present invention also provides a medical image management system and method that pushes electronic records containing medical images to healthcare providers outside of the medical imaging center soon after the medical images are taken so that the healthcare providers may view the images without the need to remotely access a central image storage cite and find and download a specific, desired image for viewing.

The invention also provides a medical image management system and method that keeps a medical image history record of times and locations where electronic records containing medical images are pushed to and viewed by parties such as healthcare providers and patients outside of the medical imaging center, and that communicates the medical image history record to the medical imaging center which produces the image.

The invention also provides a medical image management system and method that transmits lossless or substantially lossless medical image records to healthcare providers outside of the medical imaging center without requiring the healthcare provider to spend a significant amount of time to access and view the associated medical images.

Accordingly, one mode of the invention provides a medical image management system that includes a medical imaging system, a local image workstation, and a central data management system. The medical imaging system produces an electronic record in a computer-readable format and that comprises an electronic image associated with a region of a patient's body. The local image workstation communicates with the medical imaging system along a local interface such that the electronic record may be transmitted from the medical imaging device and received by, the local image workstation. The central data management system communicates with the local image workstation along a remote interface such that the electronic record may be transmitted from the local image workstation and received by the central data management system. The central data management system is also configured to push the electronic record to a pre-determined remote viewing system in a format such that the electronic record may be read and the electronic image converted to a recognizable, visible format.

According to one aspect of this mode, at least one of the medical imaging system, the local image workstation, and the central data management system is adapted to transmit the electronic record in a DICOM format. In another regard, the central data management system is adapted to receive and process the electronic record in a DICOM format.

According to a further aspect, in the event the medical imaging device does not produce the electronic record in a DICOM format, the local image workstation is adapted to convert the non-DICOM electronic record into receives into a DICOM format for transmission to the central data management system.

According to another aspect, the central data management system pushes the electronic record to the remote viewing station in a substantially uncompressed form with respect to the original size. In one more particular variation, the central data management system is adapted to push the electronic record to the remote viewing station without the electronic image being compressed more than about 3 times with respect to the original size. Further to an alternative embodiment, the central data management system pushes the electronic record to the remote viewing station with substantially lossless compression with respect to the original form and size. In another regard, the record is pushed with no loss. In still a further variation, there is at least about 1.5 times compression with respect to the original record size.

According to another aspect of this mode, the remote interface uses the internet. In another aspect, the remote interface uses a digital subscriber line (DSL) interface.

According to another aspect, the medical imaging device may be any one of the following: magnetic resonance imaging devices, CT scanner devices, ultrasound devices, computed tomography devices, nuclear medicine devices, and digital radiography or X-ray devices.

According to another aspect, each one, taken individually, or both of the central data management system and local image workstation have storage systems adapted to store the electronic record.

The system according to this mode may also further include a remote image viewing system that communicates with the central data management system along a second remote interface such that the electronic record is pushed from the central data management system and received by the remote image viewing system. The remote image viewing system may also have its own storage system which is adapted to store the electronic record. This aspect of the system may also further include an image history record system having a remote history record system associated with the remote image viewing system and a central history record system associated with the central data management system. The remote history record system sends a remote system message along the second remote interface to the central history record system and includes information related to at least one of: a time that the electronic record is received at the remote image viewing system, a time that the electronic record is opened at the remote image viewing system, and a time that the electronic image is viewed at the remote image viewing system. This image history record system may also in a further variation include a local history record system associated with the local image workstation, such that the central history record system is adapted to send a central system message along the second interface to the local history record system with at least a portion of the information contained in the remote system message.

According to still a further aspect of this mode, the central data management system comprises an internet-accessible applications service provider (ASP) with an application which is adapted to perform an operation based upon the electronic record that produces a result that is useful in managing the patient's healthcare. In one variation, this application comprises a radiology information system (RIS) that is adapted to store healthcare management-related data with the electronic image as a part of the electronic record. In a further variation, the RIS stores healthcare billing-related information in the electronic record. In another further variation, the RIS stores time-based scheduling-related information associated with the patient's healthcare in the electronic record.

Still another aspect of this mode includes a printer that is adapted to interface with at least one of the medical image system, local image workstation, or central data management system and which is adapted to print a recognizable, visible film associated with the electronic image.

Another mode of the invention provides a medical image management system with a medical imaging means, an image storage means, and an imaging pushing means. The medical imaging means is located at a first location and is for producing an electronic record in a computer-readable format and that includes an electronic image associated with a region of a patient's body. The pushing means pushes the electronic record along a remote interface to a remote image viewing system at a second location that is remote from the first location. Further to this mode, the electronic record is pushed in a format that may be opened such that the electronic image may be converted into a recognizable, visible format.

One aspect of this mode also provides a viewing means associated with the remote image viewing means for viewing the electronic image at the second location. Another aspect also provides means for providing information related to the patient in the electronic record. Yet another aspect provides a DICOM conversion means for converting the electronic record from a non-DICOM format to a DICOM format. Still a further aspect of this mode provides an image history record means for maintaining an image history record related to at least one of the transmission of the electronic record, the receipt of the electronic record, and the viewing of the electronic image. In one regard, this image history record means maintains an image history record related to each of the transmission of the electronic record, the receipt of the electronic record, and the viewing of the electronic image. In one highly beneficial variation, the image history record means includes: means for centrally managing the image history record at a central data management system located at a third location which is remote from the first and second locations; means for communicating the image history record from the central data management system to a local image workstation at the first location; and means associated with the local image workstation at the first location for displaying the image history record.

Another aspect of this mode provides DICOM conversion means for converting the electronic record from the medical imaging means into a DICOM format.

Further to another highly beneficial and desirable aspect of this mode, the image storing means includes a local storage means, a remote storage means, and a central storage means. The local storage stores the electronic record at the first location. The remote storage means stores the electronic record at the second location. The central storage means stores the electronic record at a third location that is associated with a central data management system and that is remote from the first and second locations. In one more detailed variation of this multi-storage aspect, the central storage means comprises a back-up storage means for storing the electronic record at a fourth location that is remote from the first, second, and third locations.

One further aspect of the pushing means according to this mode includes a local pushing means and a central pushing means. The local pushing means is at the first location and pushes the electronic record to a central data management system at a third location which is remote from the first and second locations. The central pushing means is associated with the central data management system at the third location and pushes the electronic record from the third location to the remote image viewing system at the second location.

Another further aspect of the pushing means according to this mode includes a central data management system at a third location that is remote from the first and second locations. The central data management system receives the electronic record from the first location and pushes the record to the remote image viewing system at the second location.

According to still a further aspect of this mode, a display means associated with the remote image viewing system displays the electronic image in a recognizable, visible format at the second location.

Another mode of the invention provides a medical image management system with a local image workstation, a central data management system, and a remote image viewing system, all respectively configured and networked such that the local image workstation pushes the electronic record via the central data management system to the remote image storage system. More specifically, the local image workstation communicates with a medical imaging system along a local interface at a first location. The local image workstation receives an electronic record that includes at least in part an electronic image from the medical imaging system associated with a body of a patient. The central data management system communicates with the local image workstation along a first remote interface from a second location that is remote from the first location, such that the central data management system receives the electronic record from the local image workstation. The remote image viewing system communicates with the central data management system along a second remote interface from a third location that is remote from the first and second locations. The remote image viewing system has a remote image storage system adapted to store the electronic record in a computer readable format, and is adapted to open the electronic record from the remote image storage system and to convert the electronic image into recognizable, visible form.

According to one aspect of this mode, the central data management system has a central image storage system that is adapted to store the electronic record in a computer-readable format. In one further variation, the central image storage system includes a back-tip storage system that is adapted to store the electronic record in a computer-readable format at a fourth location.

In another aspect of this mode, the local image workstation includes a local image storage system that stores the electronic record.

According to another aspect, the system further provides an image history record system associated with at least one of the local image workstation, central data management system, and remote image viewing system. This image history record system maintains an image history record that contains history information related to at least one of locations where the electronic record has been sent, locations where the electronic record has been received, times when the electronic record has been sent to a location, times when the electronic record has been received at a location, times when the electronic record is opened at a location, and times when the electronic image is viewed at a location.

One more variation of this image history record system according to the present mode also provides a remote history record system associated with the remote image viewing system, and a central history record system associated with the central data management system. The remote history record system sends a remote system message from the remote image viewing system to the central history record system and which contains the history information related to activity at the remote image viewing system. The central history record system sends a central system message to the local history record system and which contains at least a portion of the history information contained in the remote system message. In a further more detailed variation the local image workstation is configured to display the history information.

Another mode of the invention is a medical image management system with a medical imaging system, a local image workstation, and means for pushing the electronic image to a remote image viewing, system in a format such that the electronic record may be converted in order to represent the electronic image in a recognizable, visible format.

The medical imaging system produces the electronic record that comprises an electronic image associated with a region of a patient's body in a computer-readable format. The local image work-station communicates with the medical imaging device such that the electronic record may be transmitted from the medical imaging device and received by the local image workstation.

One aspect of the pushing means according to this mode further includes a central data management system, local pushing means for pushing the electronic record from the local image workstation to the central data management system, and remote pushing means for pushing the electronic record from the central data management system to the remote image viewing station.

According to another aspect, the system further includes means for displaying the electronic image at the remote image viewing system.

According to still a further aspect, the system also includes a means associated with the central data management system for processing, the electronic image in order to produce a result that is useful in the patient's healthcare management. This processing means in one highly beneficial variation includes Alzheimer's diagnostic analysis of the electronic image. Another highly beneficial variation includes MR spectroscopy application to the electronic image.

Another mode of the invention provides a medical image management system with a particular central data management system. The central data management system includes a computer which communicates with an electronic transmission means along a first remote interface and electronically receives an electronic record from the electronic transmission means that includes an electronic image associated with a region of a patient's body. The computer also communicates with a remote image viewing system along a second remote interface and pushes the electronic record in a DICOM format to the remote image viewing system.

According to one aspect of this mode, the system also includes a local image workstation that communicates with a medical imaging system that produces the electronic image along a local interface at a first location. The central data management system communicates with the local image workstation along a remote interface from a second location remote from the first location in order to receive the electronic record from the local image workstation. In one more detailed variation, the local image workstation transmits the electronic record, and the central data management system receives the electronic record, in the DICOM format.

According to another aspect of this mode, the central data management system is associated with an image history record system that maintains an image history record with information related to at least one of: locations where the electronic record has been sent from the central data management system, locations where the electronic record has been received from the central data management system, times when the electronic record has been transmitted from one location to another location, times when the electronic record has been received at one location from another location, times when the electronic record is opened at a location, and times when the electronic image is viewed at a location.

Another aspect of this mode includes a storage system associated with the central data management system and which stores the electronic record in at least two relatively remote locations.

Another mode of the invention is medical image management system with a local image workstation which communicates with a medical imaging system along a local interface in order to electronically receive an electronic record from the medical imaging system that includes an electronic image associated with a region of a patient's body. The local image work-station also communicates with a central data management system along a remote interface in order to push the electronic record to the central data management system. The local image workstation is also adapted to receive and display a message from the central data management system related to an image history record with history information that related to at least one of: locations where the electronic record has been sent from the central data management system, locations where the electronic record has been received from the central data management system, times when the electronic record has been transmitted from one location to another location, times when the electronic record has been received at one location from another location, times when the electronic record is opened at a location, and times when the electronic image is viewed at a location.

Another mode of the invention is a method for managing medical images. The method includes in one regard receiving along a first remote interface an electronic record, which includes an electronic image that is associated with a body of a patient, from a medical imaging system located at a first location and at a central data management system located at a second location that is remote from the first location. The method further includes pushing the electronic record from the central data management system along a second remote interface to a remote image viewing system located at a third location that is remote from the first and second locations.

One aspect of this mode further includes transmitting a central system message from the central data management system and to the local image workstation, wherein the central system message transmitted includes history information that comprises at least one of: locations where the electronic record has been sent from the central data management system, locations where the electronic record has been received from the central data management system, times when the electronic record has been transmitted from one location to another location, times when the electronic record has been received at one location from another location, times when the electronic record is opened at a location, and times when the electronic image is viewed at a location.

Another aspect of this method mode further includes receiving the electronic record at the remote image viewing system and opening the electronic image at the remote image viewing system, wherein the history information comprises the time and location of the receiving and viewing of the electronic image at the remote image viewing system. This aspect also includes communicating the history information from the remote image viewing system and to the central data management system via a remote system message before sending the central history message from the central data management system to the local image workstation.

Still another aspect of this method mode includes applying an application to the electronic image using the central data management system, wherein the application produces a result that is useful in the patient's healthcare management. The method according to this aspect further includes attaching the result to the electronic record to form a supplemented electronic record, and transmitting the supplemented electronic record from the central data management system to at least one of the local image workstation and the remote image viewing system. One particular beneficial variation of this aspect includes using an application that produces a result useful in diagnosing a parameter associated with Alzheimer's Disease. Another variation includes applying an MR spectroscopic analysis of the electronic image.

Another aspect of this mode includes pushing the electronic record from the central data management system to the remote image viewing system in a DICOM format.

Still a further aspect includes pushing the electronic record to the remote image viewing system without substantially compressing the electronic image.

Yet another aspect includes pushing the electronic record to the remote image viewing system after performing substantially loss-less compression to the electronic image.

The systems and methods of the invention for managing medical images electronically over remote interfaces such as via the internet also allow for a highly economical method for providing a medical image management ASP in a manner that expands the bottom line for medical imaging centers in particular. Therefore, the invention also includes various modes associated with the economical cost-flow related to the implementation and use of the medical image management sytems of the invention.

Another specific mode of the invention therefore is a method for providing medical image management system. The method provides a local image workstation that communicates with a medical imaging system managed by a medical imaging center along a local interface at a first location. The local image workstation is configured to receive multiple electronic records from the medical imaging system each comprising at least one electronic image that represents at least a portion of a patient's body. The method also provides a central data management system that communicates with the local image workstation along a remote interface from a second location that is remote from the first location. The method also provides a remote image viewing system that communicates with the central data management system along a second remote interface from a third location that is remote from the first and second locations. Once the local image workstation, central data management system, and remote image viewing systems are installed and interfaced, the method further includes pushing the electronic records from the local image workstation to the remote image viewing system via the central data management system and along the first and second remote interfaces.

Further to this mode, the prior recited steps are performed while charging only the medical imaging center a pre-determined, fixed, periodic fee for the pushing of the electronic records through the central data management system regardless of the volume of electronic records pushed per modality. The party responsible for receiving the images at the remote image viewing system is not charged for the viewing system, which is generally downloadable, or for the receipt of the images. The imaging center is not charged for the local image workstation or for the transmission of any given image in a direct way. Regardless of how many images are sent via this system, or to how many places, the imaging center pays the same

One aspect of this mode further includes providing a communication link for the first and second remote interfaces with the central data management system via an IP address associated with the central data management system on the internet.

Another aspect of this mode further includes providing the remote image viewing system at least in part by providing software that is downloadable over the second remote location onto a computer at the third location. In one particularly beneficial variation of this aspect, the software may be downloaded free of charge.

According to another aspect, the local image workstation comprises a computer, and the local image workstation including the computer is provided to the medical imaging clinic for use in the medical image management system without directly charging the medical imaging clinic for the local image workstation.

Still further to another aspect, the method also includes providing a medically useful diagnostic application on the central data management system that is adapted to perform a diagnostic operation on the electronic image at the central data management system to produce a medically useful result, and communicating the result to at least one of the local image workstation or the remote image viewing system in a computer readable form, wherein the result is provided without directly charging the medical imaging clinic or a user operating the remote image viewing system on a per-use basis of the diagnostic application.

An alternative embodiment of the invention provides a polling system located with the remote workstation, viewer or system. The polling system is an automated system within the remote workstation or viewer that polls the central data management system for queued data. The polling system may poll the central data management system on a preset schedule or periodic basis. It may also poll for data upon occurrence of a predetermined triggering event. Such events may, for example be booting the computer, a predetermined log in, establishing or re-establishing an internet connection, detecting a change in an assigned IP address.

In a first embodiment of the polling system, the polling system includes: an IP address identifier, IP address notifier, a data request device and an internal poller. The IP address identifier internally determines the connection status and IP address, e.g., assigned by an internet service provider. The IP notifier, after proper authentication, notifies the central database of the current IP address. The data request device requests queued data from the central data management system. The internal poller polls the viewer, workstation or system for the occurrence of a predetermined event that triggers the IP address notification and/or data request.

In variation of the polling system, the polling system is provided with the image push system that uses push technology as described above. According to this embodiment, the polling system will notify the central data management system of the image system, workstation or remote viewer's IP address. The central data management system will store the last known IP address in its database, for example, in a look up table. When the central data management system receives an image or other data, it will attempt to push the image or other data to the last known IP address of the specified remote location. The central data management system pushes data to locations over the Internet using push technology known to one of ordinary skill in the art, in the unique medical image delivery application and system described above with respect to FIGS. 1-6. If the delivery fails after a predetermined number of attempts, the data will be placed in a queue in the central data management system with a destination identifier that identifies the intended recipient. The central data management system delivers the queued data to the remote location when the remote module's polling system notifies the central data management system of the its current IP address or when the polling system requests delivery of queued data.

The data delivered by the central data management system may be the image itself or related information, for example, the review history, radiologist or physician notes, text, voice-overs, time, date and person reviewing the images, comments, instructions, as well as other information relating to diagnosis, treatment or the patient's medical record.

Another aspect of the invention provides an internal polling system within the local image station for communicating IP address information to the central data management system. Accordingly, in a similar manner, the local system will update its IP address information and request queued data stored in the central data management system. The central data management system will then send queued data such as information concerning delivery and review status of the delivered medical image, to the local system.

In one embodiment, the polling system within a particular module sends a signal to the central data management system when a particular event has occurred. The signal may either update the IP address and/or request queued data that was not successfully delivered to the module. The event may be, e.g., turning on the system, rebooting the system, connecting to the internet, reconnecting to the internet, internet server IP address reassignment or the expiration of a preset time interval. In this regard, the module's internal software may be structured so that when the module is turned on or booted, the execution program includes sending a signal to the internal poller that an event has occurred. Alternatively, the programming may directly instruct the notification and request device to update the IP address or request queued data from the central data management system. Additionally, the software may be structured to conduct periodic internal polling for changes such as IP address change or loss of Internet connection. For example, the IP address may be identified and stored in a file. Periodically, the stored address will be compared with the current IP address identified to the module to determine if a change has occurred. Such programming may be accomplished by way of computer programming techniques generally known in the art.

The polling event may be the passing of a predetermined time interval. For example, on a periodic basis, the polling system may check the central database for queued data and/or may update the central database's look up table containing IP addresses.

The central data management system tracks delivery attempts and maintains a database of such attempts, successes and failures. As described above, the central data management system stores the images and any associated data including delivery and access information, whether originating from a local system, remote system or the central data management system.

The polling system of the present invention provides efficient image delivery to locations or modules that do not have static IP addresses. The system is compatible with more economical, dial-up Internet services. If, for example, an Internet server is designed to switch or change IP addresses during a session, the change in IP address may be updated in the central database.

According to the invention described herein, images from an imaging center are delivered to a database and routed to the viewer without requiring the user to access the database to retrieve image data.

In an alternative embodiment of the medical image management system the images are automatically delivered and stored on the remote viewer in a manner so that a dedicated IP address is not required and the images may be delivered through standard firewalls if desired. Further, the invention provides an image viewer that stores the image and key information identifying the image, in a relational database at the viewer or viewer's local network.

Another aspect of the invention provides for packaging a medical image for secure transmission. Preferably, the packaging occurs at an image viewer or local workstation. The image is preferably an attachment to a horizontally applicable secure transmission package. The image is first formatted in a recognizable format such as DICOM and then is attached or packaged for secure transmission. Because a DICOM file has vertical applications to medical imaging and does not provide for secure transmission (it is preferably used for its file formatting capabilities and not its transmission protocol), a separate transmission package such as an e-mail format is used with SSL to provide secure transmission. The packaging system uses the e-mail header with a secured layer to securely deliver the attached image file to a central database where it is archived. The packaging system also packages the image file with routing instructions for delivering the image file to a remote viewer.

According to one preferred embodiment, an image file is delivered to a viewer located remotely from a data center where images from an imaging center are archived. The image file is then routed to the remote viewer with a header indicating the type of file attached, origination and recipients. The image file also contains key information that identifies the image file. The viewer receives the image file, stores it, extracts key information and stores the key information in a relational database local to the viewer (preferably at the viewer). The package contains information on the type of attachment so that the viewer understands how to extract and store the information in the attachment. The information extraction and image storage is completed in a background process at the viewer so that each individual file does not require action by a user at the viewer and so that the image and database are updated for the user when the user accesses the viewer database.

The information may be delivered to the viewer using one of several communication mechanisms, for example pushing, polling, or a combination of both transmission techniques. According to one embodiment, a polling system at the remote viewer polls the data center for queued files or files ready for delivery in a manner that will allow the data to be delivered to the remote viewer so that it is ready for a user to view. One variation provides for delivery of image files through a standard firewall. A poll request from a viewer allows the data center to deliver the data to the remote viewer so that it is available at the remote viewer when a physician or other user needs it. Accordingly, the image and data files are provided without requiring the physician or user to login and wait for the files to download at the time the user desires to view the files. The poll request is a request initiated by the viewer for example, upon a predetermined event or periodically, such as described above with respect to the polling system of the invention. In this particular embodiment, the poll request from the viewer uses a recognized protocol that permits the viewer to receive data from the data center upon submitting a poll request. The polling system acts in the background of the remote viewer so that upon the background poll, data awaiting delivery at the data center is delivered to the remote viewer and stored by the remote viewer for future access by a user.

The communication system for communicating information between the remote viewer and data center preferably uses a horizontally applicable standard information exchange mechanism such as e-mail, XML, FTP, HTTP, etc. Various communication protocols may be used in the present invention, for example, POP, SMTP, IMAP, XML, WAP, etc.

In one preferred embodiment, the viewer is configured as a mail client, which polls the sender/receiver (configured as a mail server) at the data center for mail. According to this embodiment the sessions over a remote interface between the data center and the remote viewer are initiated by the remote viewer.

A feature of a preferred embodiment provides tracking information associated with the files. The tracking information is preferably stored in the relational database at the data center. The tracking system includes message generation systems at the viewers and local workstations at the imaging centers that create tracking messages whenever events occurs such as receiving and image viewing a study, rerouting an image, correcting address or delivery errors, etc. The tracking information is available for an administrator to review. The administrator may be at the image center where address errors are typically handled. The administrator may also be at the data center where other errors may be handled. In addition, it may be desirable to provide the viewer with administrative review or access to viewing tracking information.

In a preferred variation of the invention, an image is converted at the imaging center's local workstation to an image file having a standard medical image format such as DICOM. The image file will also contain various data (“key information”), for example, patient information, study, sequence and image information or numbers, radiology center information, referring physician, radiologist, date, etc. Other files may be attached to the image file at various stages of the image file review and exchange, e.g. at the viewer.

In one particular embodiment, software at the imaging center's local workstation creates a message to which the image file is attached. The message is addressed to a sender/receiver (in one embodiment a mail server) at the data center. The information concerning the intended recipient is provided in the image file. If more than one user is specified for delivery of images, then each viewer is provided in the image file or is designated in the user or location preferences preprogrammed into the database. The message is transmitted through a secure port to the data center using a telecommunications interface and protocol such as, a version of SMTP, or POP, or IMAP, which will verify the successful submission of the message.

In order to transmit the image file, it is encoded, e.g., for e-mail transmission, for example, using a commonly recognized standards-based mechanism such as MIME. A secure layer such as SSL or TLS (hereinafter “SSL”) is added to the file for secure transmission. The file is delivered to the data center, which is SSL enabled. The e-mail is sent directly to the data center, which uses e-mail protocols to deliver and receive image files. The image file is received by the data center in a way that guarantees completion of the job before it is seen by processing logic. The delivery protocol will then confirm receipt of the e-mail at the data center. No ISP mail relays are used to route the e-mail to the data center. Thus, the delivery chain is under control of the medical image management system. The operation of the code that performs this SMTP exchange does not affect any standard e-mail mechanisms that exist at the imaging center's local workstation (or remote image viewer.) After the image has been sent to the data center, retrieval, extraction, routing and archiving logic will store the file in a filesystem and the key information in a relational database. In use, the routing logic periodically reads from each mailbox. When the logic reads from the sender/receiver, it reads the attachment's header to find the identifying information that indicates what is contained in the attachment if any, will contain any status information, and will identify the sender of the e-mail. The logic then extracts the e-mail attachment and stores it in the file system. It then extracts the image file's key information for verification and routing purposes as well as for storing. The key information and relevant identifying information are stored in the database and are linked to the location of the stored file. The logic will then create route requests to transmit the image file to the appropriate viewer based on routing logic that determines where the image file is to be forwarded. The system includes a tracking system that tracks the status of the images, image sequences or studies, i.e. whether they have been delivered, reviewed, etc. The tracking information is stored in the relational database.

After the image file has been marked with a route request, route verification logic verifies that the destination or receiving party is known or is a registered user. The logic will also determine whether the user is authorized to receive such file. The messages with verified route requests are marked for delivery while those not verified are flagged for administrative review preferably by an administrator either at the imaging center or the data center. After the messages have been verified for delivery, prefetch logic is used to identify and mark related patient files for delivery. For example, the file may be an updated file that is to be associated with a previously sent file. The previously sent file may be forwarded as well. The file is placed in the e-mail mailboxes corresponding to the user/recipient. Within the data center, mailboxes are preferably set up for each professional user's viewer or viewers, to provide privacy and minimize the risk of cross population of studies. In one variation, the imaging centers may be provided with mailboxes as well, e.g. for receiving confirmations or other messages.

After the e-mail has been forwarded, the image file and associated tracking information is archived in a database archive system, which is preferably a backup system such as a tape. Once forwarded and saved, the e-mail may be deleted from the mailbox. Archive logic is then used to swap study records from online storage to offline storage. The archive logic includes logic to restore archived files when requests are made from a viewer or workstation to view the archived files.

The user's PC's or viewers have background and foreground processing elements. The background element invisibly exchanges information over the connection with the data center. Once studies are transmitted to the viewer, they are automatically stored in the viewer's database. Key information from the files are extracted and are placed in a local relational database so that the files may be easily viewed and/or manipulated at the viewer. The image files are then available for viewing through foreground processes accessible and viewable by a user at the viewer. Preferably the foreground processes provide a display and access organizational structure that is based on extracted key information. The foreground processes may also provide additional functions that typically require files be located at the viewer, for example, three dimensional modeling that may be used to prepare for future surgery or may aid in the diagnosis and/or treatment of a patient. Other functions, for example, may include the ability of the user to annotate, or mark an image and forward such annotations or marks to others reviewing the image.

In one system, the viewer's PC polls the sender/receiver at the data center (which is preferably at a fixed address), periodically requesting mail be delivered from the destination user or viewer's receiver. Anything awaiting pickup, i.e., with a verified route request, is automatically downloaded to the user's PC and made available for viewing. This polling activity occurs in the background of the PC operation and the user does not have to do anything to make it happen. The user mail client is preferably a version of POP polling utility that runs in the background and is configured with the IP address of the data center, and a login and password for each user using that particular viewer.

When the viewer retrieves the message from the database, it parses (i.e., breaks down giving form and function to each part) the subject line of the message to determine the attachment or object type, e.g., image, report, overlay, or other attachment. A unique identifier or number is preferably provided for each study and image in the subject line. If there is a report, for example, the report will be provided with the study identification number. The object is extracted from the image and installed in the database.

The user may create overlays on the images, for example, to point out areas of interest. The overlays may be saved and forwarded to other users through the data center following a similar transmission process. The overlay is stored in the database and forwarded to all other users who received the original message. Other attachments may be rerouted as well, for example, a radiologist or other physician may prepare a report, and voice, video or other attachments may be forwarded to other users through the data center. The data center receives these user objects transmitted from the viewer through viewer background processes similar to the viewer data receiving process. The message received from the user (the header and/or attachments) is parsed for identifying information, e.g., the type of message (header); and if appropriate other key information (may be found in header and/or attachment); if it is a an image, the physician, imaging center, date, body part, study, sequence and image numbers, if it is a report, to which study etc. it belongs; if it is an annotation, to which image it belongs; if it is a status, what the status is and to which study it is associated (typically from the attachment). The message is forwarded to all of the other recipients (unless it is a status message in which case it is appropriately stored in the database at the data center).

Mail that could not be automatically routed or that failed to be verified may be accessed by an administrator, e.g. at the imaging center, and may be corrected for errors and resubmitted through the process. The administrator allows the imaging center to create, monitor and enable file transfers to users. The administrator at the viewer may be provided with the ability to create new routes, e.g., to other viewers, to insurance companies for pre-approval processes, etc.

In some situations, the imaging center and the radiologist may be in the same location. A sender utility may be provided at the imaging center's local workstation whereby the images are sent directly to the radiologist from the local sender utility. Messages regarding the file and review status are forwarded to the data center for storage in the relational database, filesystem and archiving.

In addition, the database at the viewer may be provided with alternative systems to import, package and store data compatible with the packaging and storage of the image files. For example, additional files may be directly imported from a physical medium e.g. a CD-ROM drive, floppy, ZIP drive or local network drive, etc, with input of key identifying information. Thus, alternative importing to the image viewer (or other database, e.g. at the imaging center or data center) may also be made available. Other ways of importing data into the local image viewer may include scanning text reports, associating with images and downloading through a USB or similar port into the database. According to a preferred embodiment, when the data is downloaded into the viewer system, key information is input into the system and stored so that a header is created that permits transmission of the data file in a manner similar to the transmission of other attachments created at the viewer such as, for example, overlays or reports.

One feature of the invention provides a lifetime storage system that allows data to be stored for the lifetime of the patient in a relatively inexpensive manner. In a preferred embodiment, the storage system is configured so that the images may be delivered through the data center upon authorized request from a provider or imaging center. The images are stored in a digital archive system such as a tape system. The location of the images are stored in the relational database at the data center. A request for an archived file may occur by a remote viewer, and imaging center or by pre-fetch logic at the data center that identifies and requests retrieval of prior related images, particularly of a patient for which a new study is received. The data center controls the retrieval and routing of archived images. The archive preferably comprises a library of tapes that may be retrieved and placed in a tape reader from which it is provided to the data center for routing. A preferred embodiment of the storage system of the present invention archives data received at the data center on a specific tape that is dedicated to a particular imaging modality and/or machine at the particular imaging center that sent the information. Thus, in a preferred embodiment, there is no commingling of data from imaging center to imaging center.

Providers, referring providers, patients, as well as imaging centers may be provided with the ability to retrieve previous studies. In combination with a lifetime storage system, a patient's images may be retrieved from the central database for the lifetime of the patient provided that the imaging centers where images where obtained stored the images on the system. According to one aspect of the invention, previous studies may be identified by the data center when a new patient study is received. Patient identifying information stored in the relational database at the data center will be searched for previous files corresponding to the patient identifying information. Such patient identifying information may include, date and country of birth, social security number if available or other country based identifying number, etc. The system may be designed to account for name changes or variations by allowing input of multiple names for a patient. The patient may determine the authorization for delivery of previous images, which is also stored in the database. The patient may update the authorization database, for example when a new study is completed at a new imaging center. Once identified and authorized, the previous studies may be forwarded by the data center to referring physician or location where the new study is sent. Thus, even if the studies were obtained at a different imaging center, if they are on the storage system, they will also be sent to the referring physician or provider for comparison to allow the most accurate diagnosis and treatment.

### BRIEF DESCRIPTION OF THE FIGURES

FIG. 1 shows a schematic overview of the medical image management system of the invention.

FIG. 2 shows a schematic representation of an electronic record having an electronic image and other header information associated therewith which is communicated between remote locations according to the system of FIG. 1 FIG. 3 shows a perspective view of hardware for the local image workstation used according to the invention.

FIG. 4 shows a schematic representation of the medical image management system of the invention as it interacts via the internet with multiple medical imaging centers and multiple remote parties needed access to images.

FIGS. 5A-D show various sequential modes of using the system of the invention for managing access, transport, storage, and history records associated with electronic records of medical images according to the invention.

FIG. 6 shows a schematic overview of a beneficial cost-flow associated with using a medical image management ASP system according to the invention

FIG. 7 shows a schematic representation of a method and system for storing, transmitting, receiving and tracking medical images and associated information of an alternative embodiment of the present invention using the polling system of FIG. 10.

FIG. 8 shows a schematic representation of a method of using the polling system set forth in FIG. 7.

FIG. 9 shows a schematic representation of the system and method of the embodiment described with respect to FIG. 7 using a polling system illustrated in FIG. 10.

FIG. 10 shows a schematic representation of a polling system of an alternative embodiment of the present invention.

FIG. 11 illustrates a schematic representation of a medical image file management system of an alternative embodiment of the present invention.

FIG. 12 is a detailed illustration of the relational database of the medical image file management system of FIG. 11.

FIG. 13 is a schematic view of an archiver of the present invention

FIG. 14 is a flow chart illustrating an exemplary flow of information in a local workstation at the imaging center of the present invention.

FIG. 15 is a flow chart illustrating an exemplary flow of information in an embodiment of a data center of the present invention.

FIG. 16 is a flow chart illustrating an exemplary flow of information in a sender/receiver of the data center of FIG. 14.

FIG. 17 is a flow chart illustrating an exemplary flow of information in a viewer of the present invention.

FIG. 18 is a schematic of background and foreground processes of a viewer of the present invention.

FIG. 19 is a chart of an example of headers used to package messages delivered to the viewer from the data center.

FIG. 20 is a chart of an example of headers used to package messages sent from the viewer to the data center.

FIG. 21 is a flow chart illustrating a packaging system and method of the present invention for packaging an object for transmission.

### DETAILED DESCRIPTION OF THE INVENTION

The present invention provides a medical image management system (1) and method that, in one particular beneficial mode using the known “Internet” communications network, functions as an “Applications Service Provider” (ASP), which terms are herein intended to mean an information management service that is centrally accessible from various remote locations. The following are specific embodiments which are contemplated among the benefits associated with the ASP and other aspects of the invention:

1. Electronically deliver medical images in electronic record form to referring physicians, surgeons, radiologists, other healthcare providers, patients, and other interested authorized, parties outside of the imaging center, preferably via “push” technology.

2. Electronically store each image at three separate locations: locally at the imaging center and at two fully redundant, secure, central data centers (and possibly a fourth storage at the remote viewing location).

3. Provide authorized, secure and fast access to the stored image data.

4. Provide special clinical and visualization applications centrally for the benefit of remote users at remote viewing systems.

The present invention will revolutionize the process of image delivery by use of a global broadband network that will connect imaging centers and hospital radiology departments with their radiologists and referring doctors. The invention provides immediate access to patient images, allowing the same diagnostic imaging information to be available at several locations immediately after completion of the procedure. Just as the fax machine completely changed the way doctors received imaging reports, (supplanting the US Postal Service, making the process faster and much more cost efficient), the present invention is believed to represent a similar revolution in the distribution of digital medical images. With the recent advent of broadband Internet connections, which by the end of 2001 will be available to the majority of the population in the form of Digital Subscriber Lines (DSL), continued adoption of this communication mode by the healthcare community will expand the significant transition in the way images are managed between remote locations according to the management system and method of the invention.

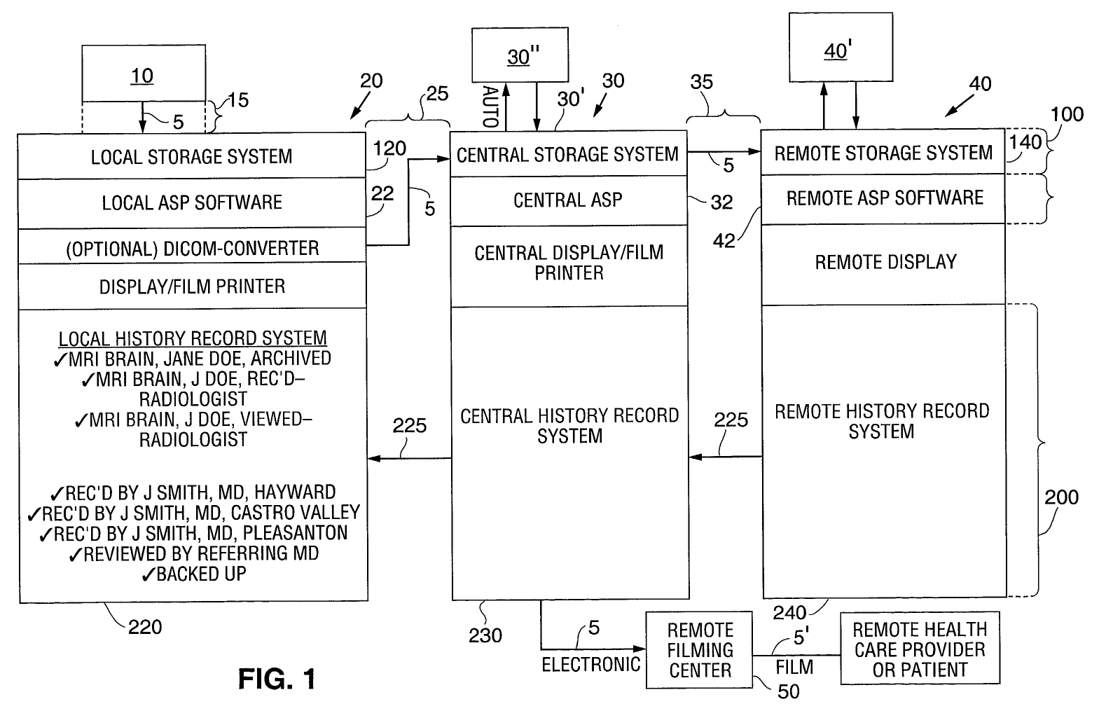

According to the invention as shown in FIG. 1, medical image management system (1) includes a medical imaging system (10), a local image workstation (20), a central data management system (30), and a remote image viewing system (40), which together provide an efficient, resource-effective, Internet-based ASP for the immediate electronic delivery and storage of medical images. In addition, an image history record system is also provided which allows for efficient tracking of when and where electronic records associated with images are transmitted, opened, and stored.

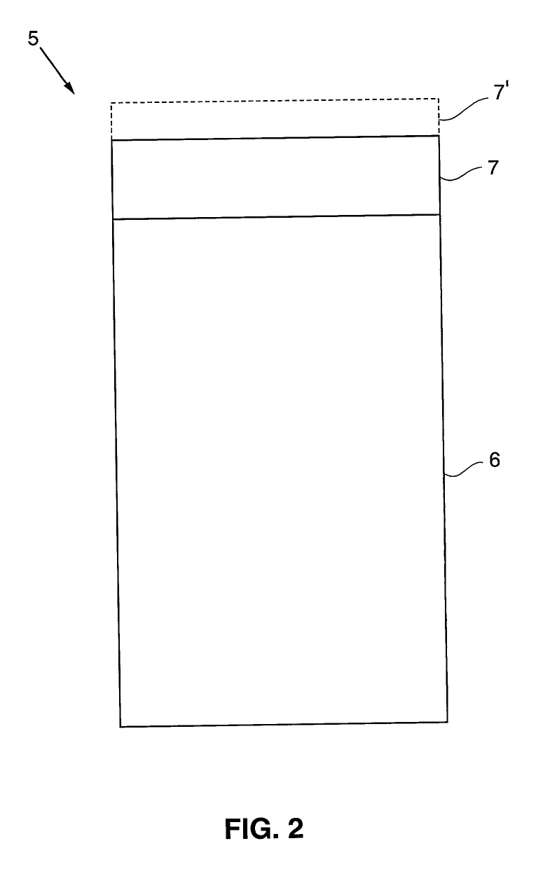

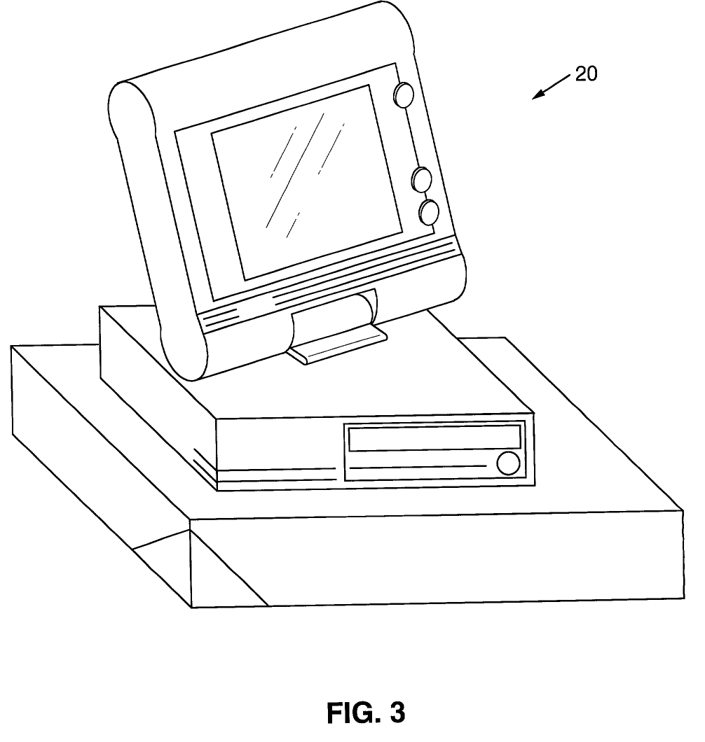

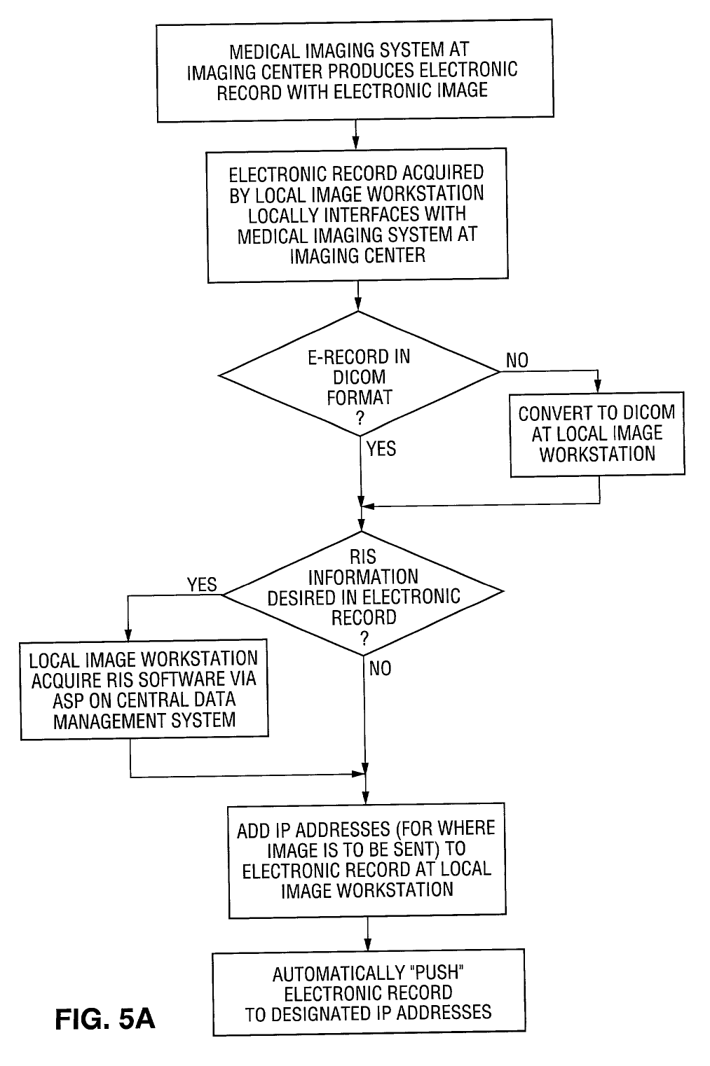

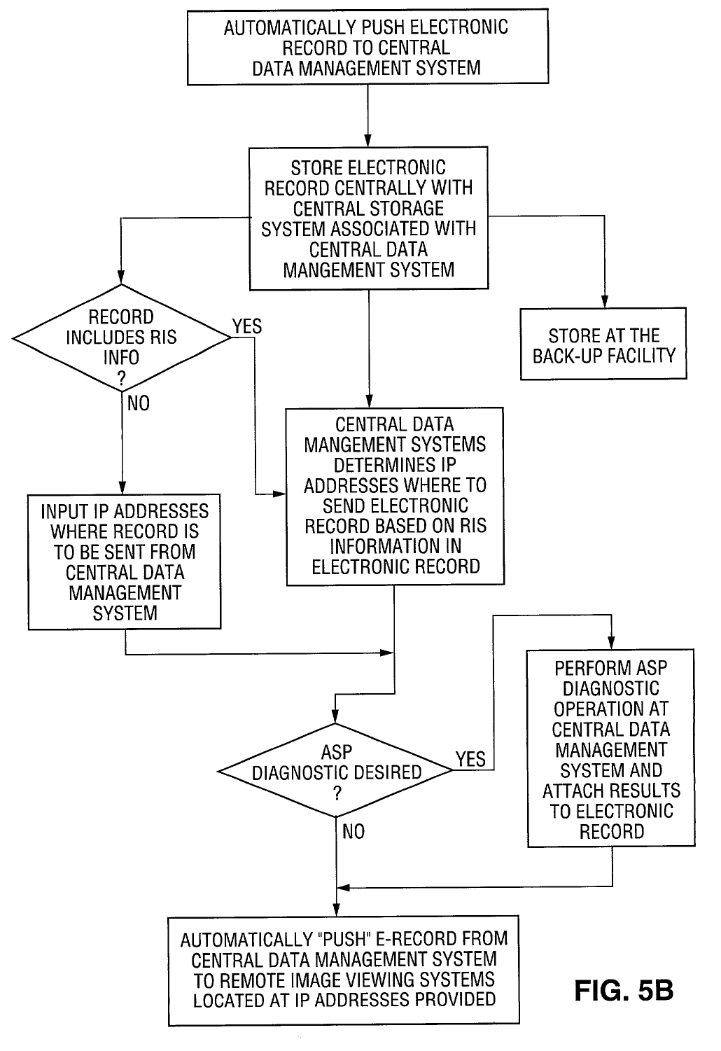

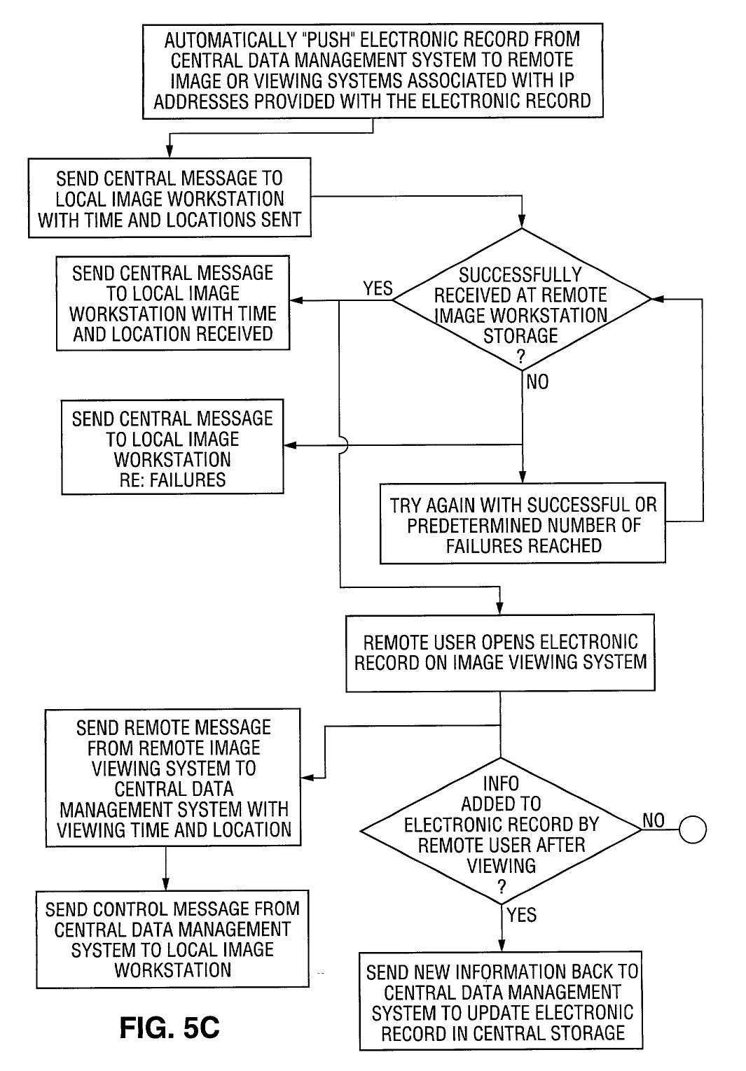

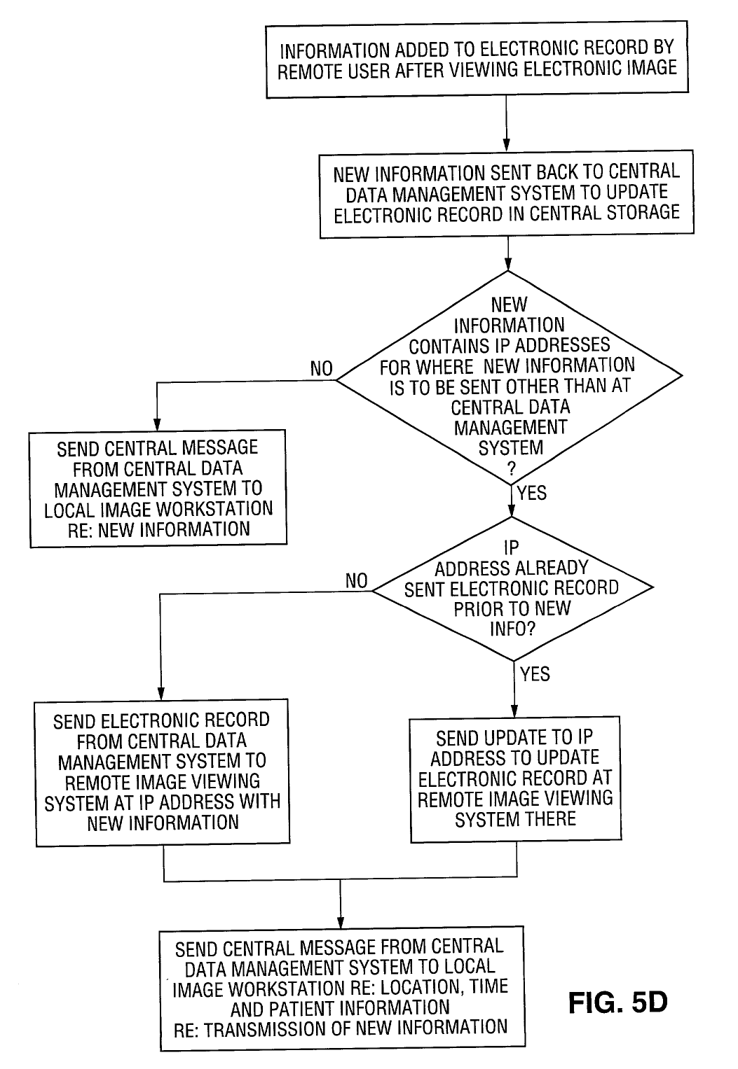

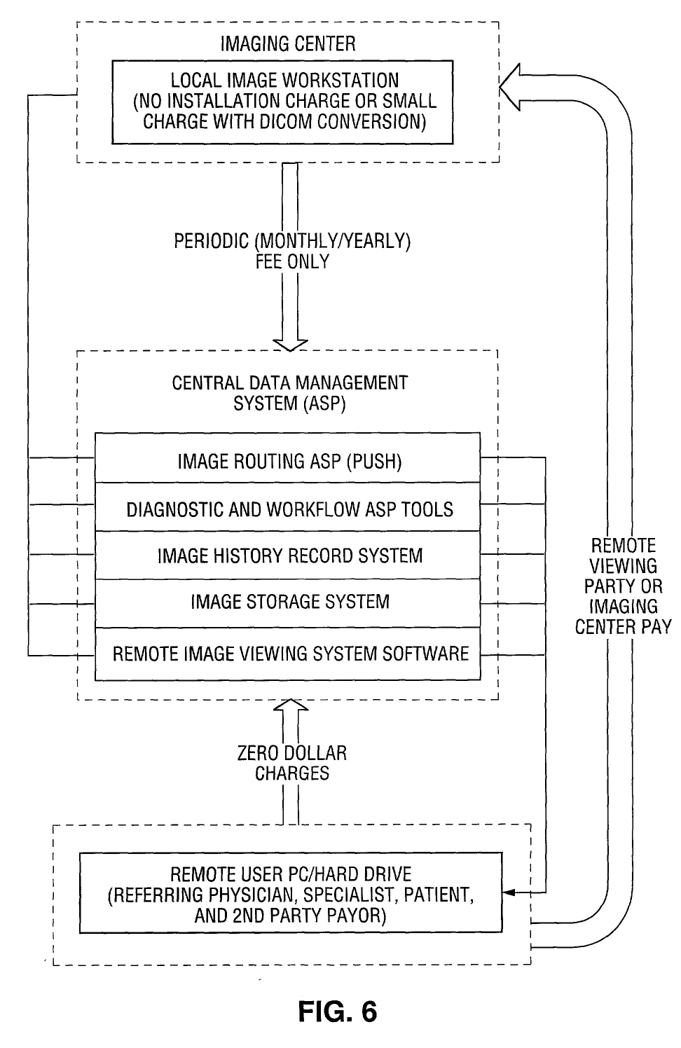

The overall system (1) of the invention is used in one general embodiment according to the following method, which is further shown in finer detail in flow-chart format in FIGS. 5A-D. A patient study or exam is conducted at a medical imaging center using medical imaging system (10) to obtain a set of images associated with a targeted region of a patient's body. These images are provided by the medical imaging system in an electronic form as electronic images (6) that are a part of an electronic record (5), as shown in FIG. 2 and further explained in detail below. The technologist performing the exam transfers the electronic record to local image workstation (20) which is also located onsite at the imaging center. The local image workstation (20) is shown in overview in FIG. 3 for the purpose of general illustration. Local image workstation (20) archives the data locally, and then “pushes” (as explained in detail below) the electronic record to central data management system (30) at a remote location, as described in detail below.

If the imaging system (10) does not output the images packaged in the format Digital Imaging and Communications in Medicine (DICOM) compliant format, local image workstation (20) will convert the data into the DICOM format prior to transmission to central data management system (30) at a remote location with respect to the imaging, center. Once the electronic record (5) is received at central data management system (30), it is stored at that remote location and automatically routed., again via “push” delivery (described in more detail below), to one or more remote image viewing systems (40) at the respective radiologist, referring physician or surgeon, or other -healthcare provider who is at another location remote from both the imaging clinic and the central data management system (30) locations. Where a radiologist is receiving electronic record (5) for viewing and interpretation/diagnosis, the radiologist in one aspect may produce a report containing new information that may be attached to the electronic record (5) and updated to the referring physician or surgeon. In addition, an image history record system (200) maintains an image history record with information regarding transmission and viewing records associated with the electronic record, and routes the respective information in the record back from these remote viewing stations, through the central data management system (30), and to the local image workstation (20) at the imaging center that produced the original image.

More detail of each component of this overall medical image management system as contemplated according to the invention is provided as follows.

Medical Imaging System

As mentioned above, the present invention broadly contemplates use of a medical imaging system (10) that provides images in electronic form for electronic delivery. In particular, the invention is believed to be highly beneficial for providing a useful ASP for managing images associated with studies conducted on MRI and CT medical image systems. In addition, the invention also contemplates the following imaging modalities as suitable substitutes for medical image system for use according to the overall medical image management systems and methods of the invention: ultrasound, computed tomography, nuclear medicine, digital radiography, etc.

Local Image Workstation

Local image workstation (20) is located at the medical imaging center and communicates with a medical imaging system (10) generally onsite at the center's location via a local interface (15). The terms ‘“local interface” are herein intended to mean interfaces that use locally managed and generally non-publicly accessed and used networks and routers. For the purpose of further illustration, local interfaces according to the intended meaning include without limitation hard-wired direct interfaces, extensions of data paths, and locally routed and/or managed LANs or telecommunication interfaces such as telephone lines that when used according to the invention do not extend beyond a locally and generally privately managed and used router and therefore generally do not use publicly accessed and used telecommunications networks, nodes, or routers.

In one highly beneficial embodiment, local image workstation (20) uses direct capture (as described above) to acquire the electronic image data from the imaging system. This ensures that the exact digital data, as stored on the imaging system, both in terms of matrix size and pixel depth, is transferred to the system of the invention. A physician or other healthcare provider can window and level (control brightness and contrast) as well as zoom and measure pathology with this data set. The physician can also use reference images to know the exact location of the image inside the body. These features are generally not present with frame-grabbed images, which again represents the technique employed by some other known electronic medical image management systems. The other advantage of this direct capture is that the image quality on the receiving end is as good as it is on the shipping end, which means that the image quality is the same as the MRI or CT technologists performing the study sees on the computer.

This contrasts with “secondary” capture methods like video frame-grabbing and film digitization, as described above. Most digital imaging modalities store pixel values as 14 or 16-bit values. The “direct” capture method ensures that the complete 14 or 16-bit information is transferred to the system of the invention. In the case of secondary capture some of the information is lost because the secondary capture technique generally only captures the S-bit analog representation of the image pixel data. Also secondary captured images cannot be manipulated to the same degree. As mentioned above, because of the inherent drawbacks of secondary captured data, the American College of Radiology (ACR) standard states that the direct capture method is preferred for primary diagnosis.

Further, the ACR standard recommends that the DICOM standard be used. Most currently installed medical imaging systems do not output the digital data in the standard DICOM complaint format. Therefore, according to this aspect special interfaces may be required to accomplish “direct” capture by generally converting the non-DICOM record to the DICOM format. Such interface may be provided as a separate DICOM workstation located between the local image workstation (20) and either the medical image system or the central data management system (30) that receives the output from the local image workstation (20). Or, the invention may also incorporate interfaces directly into the local image workstation (20) that enable the direct capture of data generated by many MRI systems, such as by providing a DICOM conversion technology within the architecture of local image workstation (20). One example of such a DICOM-converting interface is commercially available from Image Enhancement System, Inc. (IES), a California corporation, Another example of such an interface is commercially available by MERGE Technologies, located in Milwaukee, Wisconsin. Interfaces to other imaging systems may also be used or otherwise developed and integrated in the overall system and methods of the invention so as to extend the reach of the invention to those imaging systems as well. Interfaces that may be developed for MRI, CT, and other radiological imaging devices are contemplated under the present invention.

It is to be further understood that the present invention contemplates all the benefits of the systems and methods herein described without the need for a local image workstation that is peripheral to the medical imaging system if that imaging system incorporates into its own architecture the necessary communication modes for interfacing and communicating with the other components of the invention as herein shown and described.

Central Data Management System

Central data management system (30) is generally located remotely from the medical imaging center, and communicates with local image workstation (20) via a remote interface (25). Central data management system (30) is also generally located remotely from the remote image viewing systems (40) to where electronic records (5) are to be sent from the central data management system (30). Therefore, central data management system communicates with these remote image viewing systems remotely, for example via remote interface (35) as shown in FIG. 1.

The term “remote” is herein intended to mean sufficient distance away from a location such that interfacing with devices at the location is generally performed in standard course using a remote interface. The terms “remote interface” are herein intended to mean interfaces that use wide area networks (WANs) or other publicly accessed and centrally managed networks or routers such as for example cable networks and publicly accessed telecommunications networks, nodes, and routers. Therefore, in another sense remote interfaces are communication interfaces that reach beyond local interfaces as described herein. In one highly beneficial mode, the remote interfacing with the central data management system (30) for the push transfer of images to and from that central image management system will employ fast digital lines and flow over the Internet. DSL, cable, ISDN and wireless modalities will also serve as suitable alternatives for remote interface connectivity.

As an internet-based ASP, the central data management system (30) will include collocation and web hosting that may be provided for example by advanced servers such as is commercially available from Exodus. Exodus has managed services using state-of-the-art tools and experience in the key areas of storage performance optimization and security. Servers such as available from StorageTek or the Exodus Network may provide a storage service for data backup and restore solutions. A further architectural aspect of the central data management system (30) may also employ for example the Exodus giga-byte Internet service which offers speed that is 10 times as fast as conventional LANS as well as the Exodus Security Service pack. Services such as provided by Exodus offers 24×7 support, monitoring, redundant Internet access with fiberoptic cable from multiple providers, which eliminates any single point of failure. Physical security, power backup, fire suppression, extensive environmental systems, and mirrored backups at a separate geographic location are all offered by Exodus and may be employed according to the present invention.

The invention contemplates use of collocation facilities, operated by leading providers of such facilities like Exodus Communications, Inc., to house all the storage and computing equipment in particular associated with the central data management system (30). These facilities provide the physical environment necessary to keep the system and service of the invention up and running 24 hours a day, 7 days a week. These facilities are custom designed with raised floors, HVAC temperature control systems with separate cooling zones, and seismically braced racks. They offer a wide range of physical security features, including state-of-the-art smoke detection and fire suppression systems, motion sensors, and 24×7 secured access, as well as video camera surveillance and security breach alarms. Further, these facilities deliver very high levels of reliability through a number of redundant subsystems, such as multiple fiber trunks from multiple sources, fully redundant power on the premises, and multiple backup generators.

It is believed that most other medical image management ASP efforts are intending to use PCs with a Microsoft database on their central servers. It is further believed that such a database will be inadequate in many circumstances, in particular when dealing with the massive storage required by imaging centers and hospitals. For this reason the present invention preferably incorporates more robust database platform, such as for example an Oracle database on a Unix platform. This will ensure a high level of reliability and scalability. The central storage system of the central data management system (30) takes into account the storage and access needs of imaging center and remote users. The rationale behind the architecture is that: most recently stored data is the most frequently accessed data and requires the most expedient retrieval; and as the data ages, the frequency of access and the need for expediency decreases.

The invention's storage system uses a hierarchical storage management (HSM) scheme to exploit the cost/benefit ratios of different storage technologies while realizing an optimum design to satisfy the above rationale. This architecture combines hard disks and tape devices, managed by intelligent software, to leverage the fast access and throughput performance benefits of disks with the cost benefits of tape media. Various aspects of the medical image storage system as provided by the present invention are presented in the following table, showing the different storage media used and the duration for which the data resides on each type of storage device along with approximate costs.

| Time | | Storage Device | Access Time | Cost/Mbyte | |
|---|---|---|---|---|---|
| 0-30 | days | Hard disk RAID | Less than 1 second | 25 | cents |
| >30 | days | Online tape | 1-3 minutes | 5 | cents |

When data is received at the central data management system (30), it is kept on hard disk for 30 days. It is also backed up to the Primary and Secondary archives. After 30 days, the data is moved to tape media. Products like Storagetek's (Storage Technology Corp.) Virtual Storage Manager (VSM) combines hard disk, tape and software to provide high capacity and disk-like performance. By storing older data on slower media and accumulating large quantities of data on cheaper media, the storage model of the invention offers an optimum solution.

The central data management system (30) actively “pushes” the electronic records (5) and associated images (6) to the remote image viewing systems (40) of the radiologists and referring doctors as soon as the images are available. This contrasts with the “pull” model where the images are stored on a server and a user has to login and initiate a download in order to view the images. Such pull-based methods are not believed to adequately address the needs of busy surgeons and physicians who are used to having images on films delivered to them. Therefore, at each of the locations where the images would be needed, the remote image viewing station (40) would be running and available at all times on the Internet in order to achieve immediate “push” delivery of the images as soon as they become available. Similarly, it also assures prompt delivery of a report from the remote User and back through the ASP system to other locations identified. The delivery, may also be scheduled for specific times if the remote image viewing system (40) on the receiving end is known to not be available at all times. Multiple deliver attempts will also be made. The acceptance of the unique mode of constant connectivity, however, will grow considering the aggressive expansion of fast, always on Internet Connections.

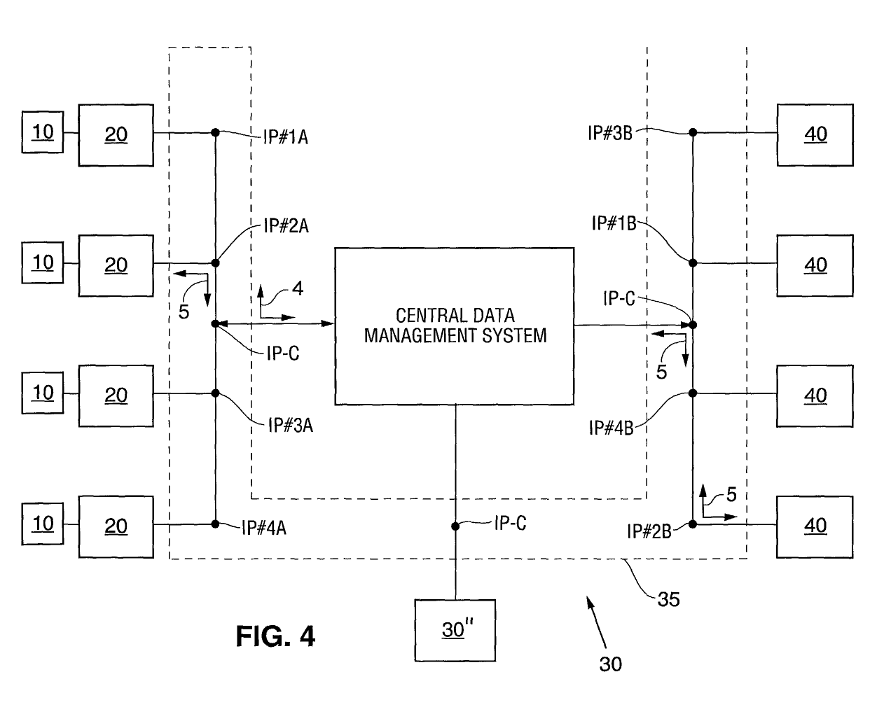

Further aspects of using IP addresses over the Internet to assist the routing of electronic records (5) to and from various facilities via the central data management system is provided in FIG. 4. Further to this Figure, the central data management system's Internet Protocol (IP)address is generally designated as “IP-C”, whereas electronic record origination addresses (local image workstations) are designated variously as IP#1A, IP#2A, etc., and destination IP addresses where the records are to be pushed are designated generally as IP#1B, IP#2B, etc. Accordingly, IP#1A pushes an electronic record (5) to central data management system (30) via its IP address IP-C, which pushes the record (5) to the desired remote image viewing systems (40) found over the internet at address IP#1B. All the desired destination addresses, including the central data management system (30) and the locations for the remote image viewing systems (40), may be designated in the header (7) associated with the electronic record (5), and may be placed there for example by manual or automated forms of entry to the record via the respective local image workstation (20).

FIG. 4 also shows electronic records (5) via flow arrows pointing in each of two opposite directions. This is intended to represent both forward and reverse flow of information related to the records (5), such as returning updated versions of the records (5) with new diagnostic information flowing from the remote image viewing system user according to various of the particular embodiments herein described and shown in the Figures. In particular, interpreting physicians, payers, and other parties outside of the medical imaging center and representing the remote image viewing systems of the invention will often attach reports to the electronic record for others to see, including the medical imaging center itself and other physicians. This is represented by the reverse flow of electronic record (5) as shown in FIG. 4, and the respective reports, etc., are shown schematically in FIG. 2 as new information (7′) which is attached to the “header” or “data” section of electronic record (5) along side of the electronic image (6).

Moreover, to the extent one party with a first remote image viewing system desires to send and image to another party with a second remote image viewing system, that may be accomplished directly from the first remote image viewing system. This is shown in FIG. 1 by way of arrows between system (40) and system (40′) that represents that other second remote system, which may be another physician, a patient, a third party payer, or any other authorized party. In another aspect, however, for the purpose of more centralized control, such party-to-party transfer may also require routing through the central data management system (30), and may even in some circumstances require pre-authorization via the local image workstation (20) that originally brought a given electronic record into the system.

In addition to the above mentioned “push” delivery service, a web-based ‘“pull” functionality will also be available to facilitate secure data access by authorized individuals from locations other than the normal delivery locations. Consistent with privacy requirements, a physician will have access to records of only those patients for whom he or she is responsible or otherwise authorized.

In contrast to other known efforts at providing a medical image management ASP, the present invention employs “push” delivery of medical images directly to the referring physician's office or offices, which may be completed according to the invention immediately after generating the image at the medical imaging center. The use of the push methodology directly addresses the needs of referring physicians prescribe the imaging study in order to diagnose or treat a patient. Clearly, these healthcare providers want the images delivered to their office(s) just as they have the films delivered today. With push delivery of electronic image records according to the invention, the image delivery will take place in the background and be on the physician's desktop computer ready for review whenever the doctor is ready to view them.

The push aspect of the invention saves costs directly equated with physician time, and is also believed to enable an increase in imaging center revenues. In one regard, referring physicians do not need to spend the time to log on to find and download the images, and in another regard medical imaging clinics that use the medical image management systems and methods of the invention will be able to use the connectivity of the overall system as a marketing advantage, attracting referring doctors and their patients who can participate in the “push” image transmission stream.

Further, the communications bandwidth requirements for speed are less stringent with the present invention's “push” model because the data transfer occurs in the background, shortly after the study is completed, and before the doctor desires to view them.

Remote Image Viewing System

In order to display and manipulate the received images, the invention in one aspect includes remote image viewing system (40) that all radiologists and referring doctors must use in conjunction with the image delivery service of the invention. The remote image viewing system in one beneficial embodiment is a software program that may be downloaded from the website associated with the central data management system (30), and run on any PC that satisfies certain minimum requirements. This program may also be available on CD ROM for distribution to doctors and/or image center users of the invention. The remote image viewing system (40) preferably gives the physician the ability to change display formats, window and level the image (adjust the brightness and contrast), magnify the image, manipulate the grayscale, measure the anatomy and pathology, easily identify spatial locations, and to the extent there is direct-capture and lossless transmission make exact measurements and determine the location of abnormalities for surgical planning.

In one further embodiment, only images delivered according to the invention will be viewable through this viewer. However, in another aspect images delivered according to the invention may be made viewable through any DICOM conformant receiver/viewer.

The remote image viewing system (40) is how physicians and other users outside of the imaging center will “experience” images transported according to the invention, and thus the system (40) Must be provided in a form that is well accepted by the medical community in particular. In a further aspect beneficial to healthcare providers, payers, and patient's alike, this viewer may be used, free of charge, to view and analyze images transported according to the invention, as further developed below.

Remote image viewing system (40) also preferably incorporates or interfaces with a database. This database in one beneficial mode is an extensive, queriable database so the physician can simply type in the patient's name or other identifying factors to bring up that particular patient immediately, even if there are hundreds of patients on the doctor's hard drive. The physicians will also be able to configure their patient image database on their computer in different ways in order to organize their patients the way they feel will be most efficient for them.

This flexibility differentiates the present invention from other medical image management ASPs that will only allow central storage of images at the company site. With the present invention, the image data, once the physician selects the patient, will be immediately downloaded into RAM on his or her computer. This allows the physician to have access quickly to the entire data set and allow for rapid change from image to image efficiently, thereby decreasing the time that the physician needs to review his patients' images. The physician will be able to view his or her patients' images even if the computer is off-line, such as when the doctor carries the laptop computer on rounds, or even to the operating room, All other known medical image management systems and methods are believed to require the physician to log on to web sites and then download the images to his computer. Hence, with other ASP systems not associated with the present invention, if the physician wishes to see his patients' images again, he must repeat the extensive and lengthy login and download procedures. It is believed that such methods which rely upon the physician to actively login and download, will be unacceptable for the referring doctors who are extremely busy and are used to images being delivered to them on film. Doctors will expect the same (image delivery to the doctor, not the doctor having, to actively seek their patient images) in the future with any digital image ASP.

The referring physicians and other users of the invention will be strongly encouraged to use DSL for interfacing the remote image viewing system (40) with the central data management system (30) of the invention since this provides for fastest and economical Internet access. Moreover, it is preferred that the Internet connection between the central data management system (30) and the remote viewing system be continuously online in order to best facilitate the “push” delivery aspect of the invention. The ability to maintain the continuous connectivity desired will improve with the ongoing aggressive expansion of fast, always on Digital Internet Connections.

Notwithstanding the significant benefits of the electronic image flow as herein shown and described, some parties will still invariably want medical images on hard-copy film. This may also be accomplished by use of the present system as shown in FIG. 1 by sending the electronic record to a film printer (50) that converts the electronic image of electronic record (5) into film image (5′) for delivery to the interested party. Because the image is stored and managed centrally, film printers that exist locally to the intended delivery location may be sent the electronic record via remote interface, and may in fact even have themselves a remote image viewing system according to the invention, at least to the extent that it is configured to open the proprietary electronic records to access the film for printing.

Diagnostic & Workflow Tracking ASP Operations

The ASP aspect of the invention also allows for specific clinical and workflow operations to be performed on the electronic image at the central image management system in a centralized and controlled environment to the benefit of all remote users of the ASP. This is shown schematically for the purpose of illustration at ASP tool (32).

In one particular embodiment, the invention provides special algorithms for processing, and analyzing images such as MRI images, such as for example in order to diagnose various conditions associated with the processed image. In one particular aspect for the purpose of further, illustration, at least one processor or software-related algorithm may be applied to the centrally stored image information in order to diagnose and stage Alzheimer's Disease. Further more detailed examples of Alzheimer-diagnostic analysis that may be offered under the ASP model of the present invention are described in the following references:

1) Meyerhoff, D. J., MacKay, S., Constans, J- M., Norman, D., VanDyke, C., Fein, G., and Weiner, M. W.: Axonal loss and membrane alterations in Alzheimer's disease suggested by in vivo proton magnetic resonance spectroscopic imaging. Annals of Neurology 36:40-47, 1994.

2) Constans, J. M., Meyerhoff, D. J., Gerson, J MacKay, S., Norman, D., Fein, G., and Weiner, M. W.: ¹H magnetic resonance spectroscopic imaging of white matter signal hyperintensities: Alzheimer's disease and ischemic vascular dementia. Radiology 197:517-523, 1995.

3) Constans, J. M., Meyerhoff, D. J., Norman, D., Fein, G., and Weiner, M. W.: ¹H and ³¹P magnetic resonance spectroscopic imaging of white matter signal hyperintensities in elderly subjects. Neuroradiology 37:615-623), 1995.

4) MacKay, S., Ezekiel, F., Di Sclafani, V., Meyerhoff, D. J., Gerson, J., Norman, D., Fein, G., and Weiner, M. W.: Alzheimer disease and subcortical ischemic vascular dementia: Evaluation by combining MR imaging segmentation and H-1 MR spectroscopic imaging. Radiology 198:537-545, 1996.

5) MacKay, S., Meyerhoff, D. J., Constans, J. M., Norman, D., Fein, G., and Weiner, M. W.: Regional grey and white matter metabolite differences in Alzheimer's disease, subcortical ischemic vascular dementia and elderly controls with ¹H magnetic resonance spectroscopic imaging. Archives of Neurology 53:167-174, 1996.

6) Tanabe, J. L., Amend, D., Schuff, N., Di Sclafani, V., Ezekiel, F., Norman, D., Fein, G., and Weiner, M. W.: Tissue segmentation of the brain in Alzheimer's disease. American Journal of Neuroradiology 18:115-123, 1997.

7) Schuff, N., Amend, D., Ezekiel, F., Steinman, S. K., Tanabe, J., Norman, D., Jagust, W., Kramer, J. H., Mastrianni, J. A., Fein, G., and Weiner, M. W.: Changes of hippocampal n-acetyl aspartate and volume in Alzheimer's disease: A proton MR spectroscopic imaging and MRI study. Neurology 49:1513-21, 1997.

8) Schuff, N., Amend, D., Meyerhoff, D. J., Tanabe, J., Norman, D., Fein, G., and Weiner, M. W.: Alzheimer's disease: Quantitative H-1 MR spectroscopic imaging of fronto-parietal brain. Radiology 207:91-102, 1998.

9) Schuff, N., Vermathen, P., Maudsley, A. A., and Weiner, M. W.: Proton magnetic resonance spectroscopic imaging in neurodegenerative diseases. Current Science Journal 6:800-807, 1999.

10) Tanabe, J., Ezekiel, F., Schuff, N., Reed, B., Norman, D., Jagust, W., Weiner, M. W., Chui, H., and Fein, G.: Magnetization transfer ratios of white matter hyperintensities in subjects with subcortical ischemic vascular dementia. Am J Neuroradiol 20:839-844, 1999.

11) Kwan, L. T., Reed, B. R., Eberling, J. L., Schuff, N., Tanabe, J., Norman, D., Weiner, J., and Jagust, W. J.: Effects of subcortical cerebral infarction on cortical glucose metabolism and cognitive function. Arch. Neurology 56:809-14,1999.

12) Schuff, N., Amend, D., Knowlton, R., Tanabe, J., Norman, D., Fein, G., and Weiner, M. W.: Age-related metabolite changes and volume loss in hippocampus by proton MR spectroscopic imaging and MRI neurobiology of aging. Neurobiology of Aging 20:279-285, 1999.

13) Capizzano, A. A., Schuff, N., Amend, D., Tanabe, J., Norman, D., Maudsley, A. A., Jagust, W., Chui, H., Fein, G., and Weiner, M. W.: Subcortical ischemic vascular dementia: Assessment with quantitive MRI and ¹H MRSI. American Journal of Neuroradiology, (In Press 2000).

The disclosures of these references are herein incorporated in their entirety by reference thereto.

Other image processing tools such as M.R. Spectroscopy (or “Proton MRS”), may also provide an ASP tool (32) for use with the invention. Proton MRS uses the MRI scanner to listen for the radiowaves of major normal proton containing brain biochemical metabolites (myoinositol, choline, creatine, amino acids, n-acetyl aspartate) as well listening for the radiowaves of abnormal proton containing metabolites (lipid and lactate). The added metabolic biochemical information impacts on the differential diagnosis of abnormal lesions seen on the anatomic MRI as being either infection, tumor or stroke all of which have different treatment regiments. In certain cases proton MRS can prevent invasive neurosurgical biopsy (so called MRS brain biopsy). Proton MRS may have a future role in the early clinical evaluation process and response to therapy in dementia such as Alzheimer's Disease. Proton MRS has its own separate CPT billing code and can be performed in 5 to 20 minutes, depending on the complexity of the clinical question. Further more detailed examples of an MR Spectroscopy operation that is believed to be well suited for use under the ASP aspect of the invention is described in the following references:

1. Boyko O B, Spielman D. Clinical Applications of MR Spectroscopy. Proceedings Seventh Annual Educational Course International Society for Magnetic Resonance In Medicine, Syllabus (1999) Pages 109-119.

2. Boyko O B. Neuroimaging and Proton Spectroscopy in CNS Neoplasms. In Stark D D and Bradley W G (eds.) Magnetic Resonance Imaging, Mosby 1999.

3. Boyko O B. MR Spectroscopy of the Brain. In Tindall G(ed.) Practice of Neurosurgery, J B Saunders New York 1996.

4. Lazeyras F, Charles H C, Tupler L A, Erickson R, Boyko O B, Krishnan K R R. Metabolic Brain Mapping In Alzheimer's Disease using Proton Magnetic Resonance Spectroscopy. Psychiatry Research 82:95,1998.

5. Ross B, Michaelis T. Clinical Applications of Magnetic Resonance Spectroscopy. Magnetic Resonance Quarterly 10:191,1994.

The disclosure of these references are herein incorporated in their entirety by reference thereto.

Such ASP-based diagnostic/image processing allows medical imaging centers using the invention to offer the respective service to a second tier of users doing business with that first doctor/user, such as for example offering the service to referring physicians, patients, and healthcare providers such as third-party payer/insurance companies. Also, the imaging center does not have to make an upfront investment in software, computer work stations and additional clinical staff—rather, the service is supplied at the central data management system (30) according to the associated ASP service. Additionally, the invention allows the owner or supplier of the diagnostic tool to reach many more patients than may be possible by creating separate, individual centers for local access and used, removing the need for example for creating a high number of localized, individual Alzheimer diagnostic centers across the country and world. The return on investment in these applications may be difficult to justify for healthcare providers such as imaging centers, radiologists, or referring physicians if such individual practice centers were required to purchase the individual applications, particularly when they are to be used in relatively rare clinical instances. Nevertheless, the applications themselves may be crucial in those specific clinical instances. Therefore, such applications when layered on top of the present invention's ASP platform will make them instantly available to a large medical community without the associated cost of ownership. As medicine becomes more complex patients will better served clinically and economically served through access to leading experts in ultra specialized procedures via the internet ASP of the present invention. Moreover, highly specialized analytical tools of the type herein disclosed can be performed with more skill, reliability and efficiency and at lower costs through the ASP aspect of the invention than under the more conventional, localized access/use modes.

The invention also contemplates ASP tool (32) as providing certain workflow software, generally referred to as “Radiology Information Systems” (RIS), for integrating the storage and communication of images with certain workflow software. RIS systems electronically attach critical patient management information (such as patient records, fee billing, and history, prior diagnosis and treatment history, etc.) to images and are generally known to provide high level, detailed workflow management capability to make radiology operations more efficient in the areas of scheduling patients, staffing, asset management, etc. The radiology community has accepted this approach, but only the- largest hospitals have purchased the necessary software and hardware, due to the prohibitive cost of individual ownership. Generally speaking, known RIS technology has much higher capacity for information flow and management than individual medical imaging, centers require. Therefore, according to the RIS/ASP mode of the invention, wherever the image goes through the system of the invention, the associated patient care information also goes too—all in one integrated electronic file, and without any individual healthcare provider needing to actually purchase the RIS system. Again, by hosting this type of application as an ASP, wider and faster adaptation will result with revenue flow managed through one central site according to the various charging structures described above.

The RIS system as ASP tool (32) may be entirely managed through internet aspect to the ASP service on the central data management system (30), or it may have various components layered over the central data management system (30) in addition to the remote image viewing system (40) and/or the local image workstation (20), as shown at remote ASP interface (42) and local ASP interface (22). In particular these local and remote ASP interfaces (22, 42) may require resident architecture at the respective local image workstation (20) and remote image viewing system (40) in order to perform their role in the overall flow of information as relates to ASP-based activities on those terminal.

Image Storage System

Medical images are archived according to the invention in multiple locations according to a storage system (100) as follows.

All diagnostic studies are “medical records” and must be stored for a considerable period of time, generally for a minimum of seven years. The present invention provides a more efficient and less expensive solution for image storage, based on the Internet-based paradigm for the distribution and storage of medical images. More specifically, the invention utilizes a three-prong approach to the storage of the digital images: 1) at the remote image viewing systems (40) generally at the referring doctors' and radiologists' practice locations; 2) at two central servers associated with central data management system (30), and 3) at the local image workstations (20) located at transmitting imaging centers or hospitals. Therefore, there will be four redundant, physically separate locations where the images are stored to ensure unsurpassed reliability and efficiency in accessing image data.

The first storage location is at a local image workstation (20) at the imaging center's or hospital's own radiology department, in a DICOM format, according to a local storage system (120). This local access will make healthcare providers that use the invention feel extremely comfortable knowing that they have access to their data directly, without needing to seek permission from a third party to access their own data. A central storage system (130) associated with central data management system (30) stores all electronic records (5) at two central back-up sites (30′, 30″) that, are separated by considerable geographic distance. The medical imaging center and the referring doctors will have extensive access to the electronic records stored on the central backups (30′30″). A remote storing system (140) stores the electronic records (5) on the remote image viewing systems (40) at as many remote locations as the respective users wish—this allows these users, in particular referring physicians and/or radiologists, to view the images at any of a number of locations that he generally frequents in performance of his work (e.g. different office sites, hospital, etc.).

Image History Record System

The invention according to another embodiment also provides for information associated with the transport, storage, viewing, analysis, and other management of a medical image to be efficiently communicated to all interested parties, herein referred to and shown in the Figures as image history record system (200)(FIGS. 1 and 5A-D).

In one aspect, medical image centers can track the entire process of image deliver storage and review from the local image workstation (20) merely by reference to the local image workstation (20) located in their respective clinic or hospital. More specifically, a local history record system (220) displays the image history on the local image workstation (20)'s monitor, and for example notifies the clinic of each successful delivery. Also, if a delivery attempt was unsuccessful (for instance the referring doctor's computer was turned off or the Internet access was down), the customer is notified so appropriate actions can be taken to assure a quick delivery. Thus healthcare providers using the system have a degree of image management that has never been possible before with film. Furthermore, when and where the images are reviewed by the radiologist or referring physician a message may be reflected on the local image workstation (20). None of the other medical image management features with their ASP.

More specifically, remote image viewing system (40) according to one beneficial embodiment operates as follows. A remote history record system (240) associated with a remote image viewing system (40) sends a remote message (235) containing information about transmission, receipt, and viewing of the record to the central data management system (30). A central history record system (230) associated with the central data management system (30) in turn sends a central message (225) including the information from the remote message (235) to the local image work-station (20). Accordingly, all image history is updated to the imaging clinic and is accessible for review and display there, real-time, via a local history record system (220) associated with the local image workstation (20).

This image history record system (200) and associated real-time access to image transmission and use information is believed to be particularly useful when associated with the “push”-based image transmission method of the invention. Because the images are pushed to various remote locations, the message feedback methods as described is important to ensure proper management by the imaging center, and so that that practice knows what is happening to the records they have produced and subsequently distributed through the ASP of the invention.

Associated Billing, Methods

Costs associated with healthcare services such as medical imaging are highly scrutinized, and economics of imaging services are directly related to widespread availability. Beneficially, the systems and methods of the invention provide for a method of cost-flow associated with the use of the medical imaging ASP that is believed to directly address such economics in order to compel rapid adoption, in particular by free-standing medical imaging clinics that are highly sensitive in particular to up-front fees and large capital expenditures. The cost-flow method of the invention will consist of an activation fee with each clinic, that may be for example approximately $10,000 which is believed to cover all of the expenses to install the local image workstation (20) in the clinic as well as applications training expenses for both the customer and for a certain set number of referring doctors. For initial customers already having DICOM interfaces, this $10,000 fee will be waived. Since these customers already have the required hardware for electronic image transport and storage as contemplated herein, the cost to start service to these customers will be minimal. These customers will be separated geographically and the first 50-100 customers will be targeted in major cities, so that the initial users will be selected geographically from throughout the United States. This provides the widest exposure throughout the country for rapid adoption.

One cost-flow embodiment of the invention charges a fixed monthly fee, in addition to waiving installation costs in certain DICOM enabled imaging centers. This is believed to be beneficial to imaging centers or small hospitals that would have to pay $100-300 thousand up front for a PACS type system and also would need extensive IT personnel support to keep the PACS operating. The cost of using the system of the invention according to this cost-flow method is less than the cost of just the IT person who would be needed for a PACS. Moreover, PACS systems do not address the issue most important to the imaging centers: delivering the images to the referring doctors quickly and reliably. In addition, the present invention does not require the cost for secondary capture equipment and a DICOM sending station that other known medical image ASP services are believed to require. Picture Archiving and Communication Systems (PACS) generally cost $60,000 to $1,000,000, and include associated inefficiencies and costs of additional personnel to run the sophisticated hardware. According, to this invention, a monthly fee, for example of approximately $4,000 or $48,000 annually, may be charged for high performance electronic delivery, storage, retrieval, and display of the digital images. In one embodiment, this is the only fee charged, independent of volume of use. According to another embodiment, a per use fee may also be charged. In either case, the ASP-related fees represent a considerable cost savings to the clinic or hospital when compared to either use of a PACS or the current use of film. The invention therefore helps imaging centers and hospital radiology departments maximize their productivity while minimizing their costs.

Still further, the mode of charging/paying for these services is simplified under the ASP model of the invention. Rather than manufacturing and selling individual workstations or software packages to each localized physician/user, under the present invention much fewer (and possibly only one) analytical tool may be created that is thus shared by each remote user of the ASP, resulting in either a “per use” or “periodic” fee structure that does not require any one, large sum payment.

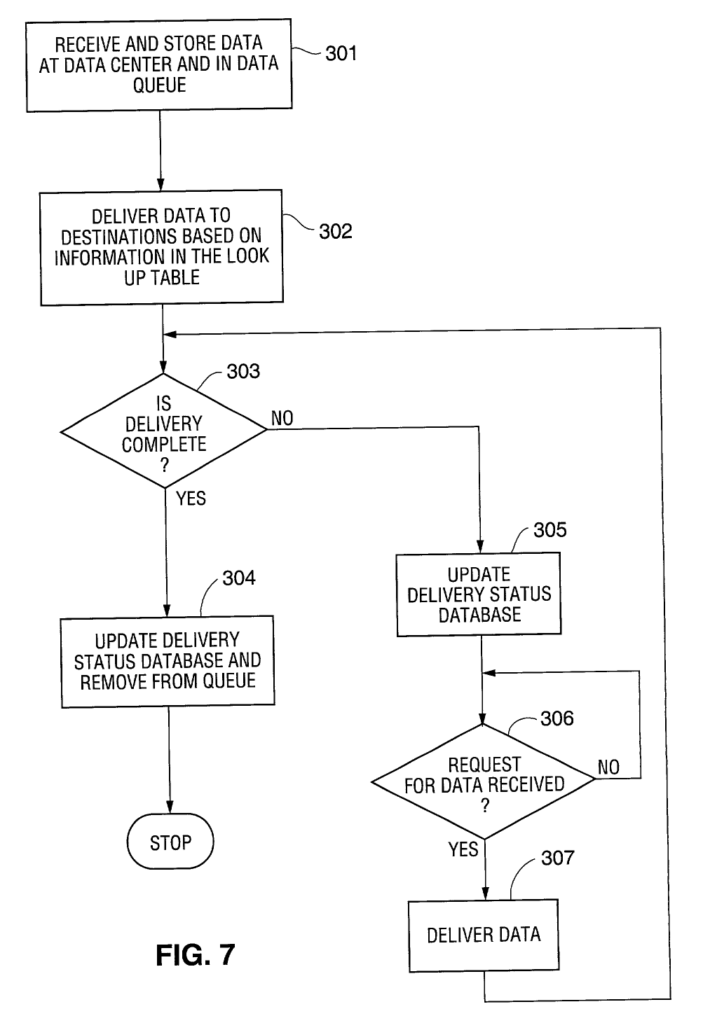

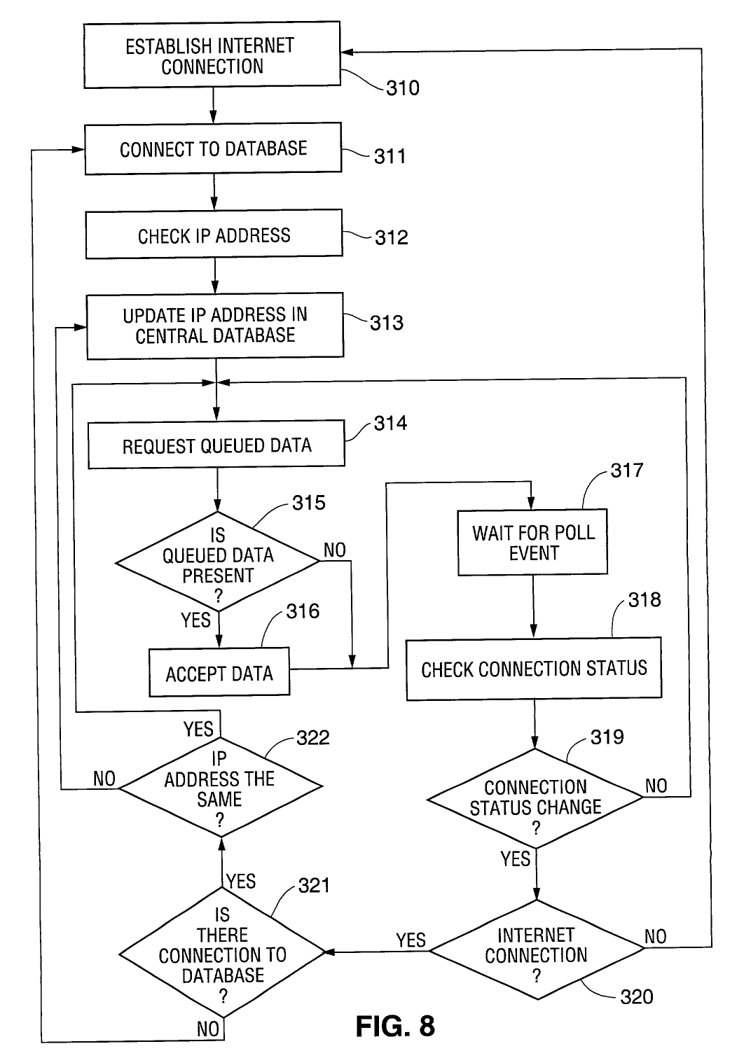

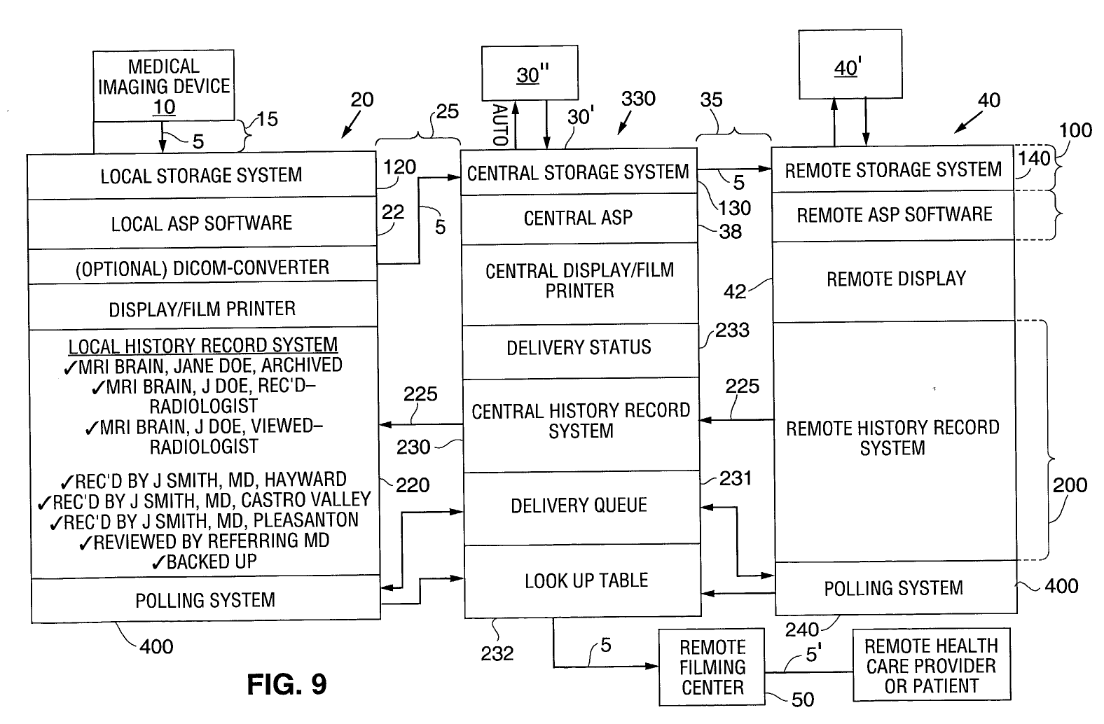

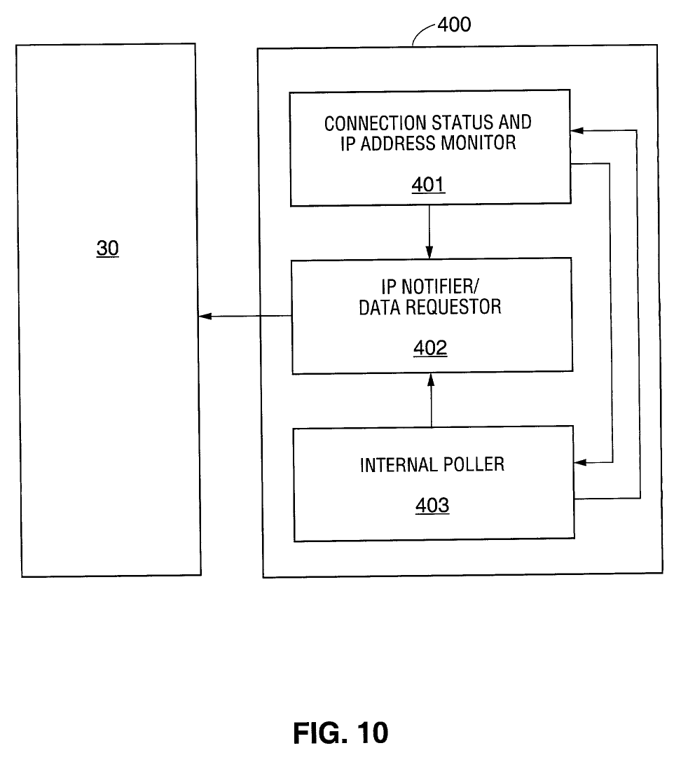

FIGS. 8 and 10 illustrate a polling system of an Alternative Embodiment. FIGS. 7 and 9 illustrate a variation of the present invention in which the medical image management system includes at least one polling system 400 as illustrated in FIG. 10. FIG. 9 illustrates a medical image management system similar to the system illustrated in FIG. 1 with like numerals representing the same elements with the corresponding description herein. The system of FIG. 9 additionally includes a polling system 400 located with each of the local image workstation 20 the remote image viewing systems 40. The polling systems 400 each communicate with the central data management system 330. The central data management system 330 further includes a delivery queue 231 that holds data for which attempted delivery has failed. Each set of data queued for delivery in the data queue 231 includes an identifier that associates the particular set of data with the intended delivery location. The identifier may also associate that data with its origin and/or its corresponding location in the central storage system 130. The central data management system 330 also comprises a look up table 232 that stores the last known IP address for each local or remote workstation, viewer or system. Finally, the central data management system 330 includes a delivery status database 233 that tracks the delivery status of all data including information relating to delivery attempts, successes and failures. In an alternative arrangement, this information may be stored with the data itself.

As illustrated in FIG. 10, the polling system 400 includes a connection status monitor 401 that tracks the Internet connection status of the module and identifies and stores the most recent IP address in an associated file. The connection status monitor 401 may also monitor the on/off status of the module, e.g., whether the module has connected to the Internet. The polling system 400 also includes an IP notifier/data requestor 402 that notifies the central data management system 330 of the current IP address and/or connection status of the module. Alternatively or in addition, the IP notifier/data requestor 402 requests queued data located in the central data management system 330 as described in more detail below. The polling system 400 further comprises an internal poller 403 that checks the connection status and signals to the IP notifier/data requestor 402 when an event has occurred. Such event may be, for example, booting the computer, establishing an Internet connection, a change in the IP address and/or the passing of a predetermined time interval.

Either the internal poller 403 or the connection status monitor 401 may signal to the IP notifier/data requestor 402 to request queued data from the delivery queue 231 in the central data management system 330 and/or provide the look up table 232 with updated IP address information. The central data management system may be not arranged to track IP addresses or to utilizing push technology. In such a case, the IP notifier/data requestor 402 may serve simply to poll the database for data.

The internal poller 403 signals to the IP notifier/data requestor 402 at the end of predetermined intervals. The internal poller 403 may also request connection status information from the connection status monitor 401 at predetermined intervals. The internal poller 403 may ask the connection status monitor 401 whether a new connection has been made. It may also ask whether the IP address has been changed. The connection status monitor 401 may also be programmed signal to the internal poller 403 when the connection status has changed. In the event that a new connection has been made or the IP address has been changed, the internal poller 403 may instruct the IP notifier/data requestor 402 to send a signal the central data management system 330, requesting queued data and/or updating the IP address stored in the central data management system 330.

Alternatively, the connection status monitor 401 may be arranged to signal to the IP notifier/data requestor 402 when the on/off connection status or IP address of the module has changed. According to this embodiment, in the event that a new connection has been made or the IP address has been changed, the connection status monitor 401 directly instructs the IP notifier/data requestor 402 to send a signal the central data management system 330, requesting queued data and/or updating the IP address stored in the central data management system 330.

In either case, the connection status monitor 401 provides the updated IP address to the IP notifier/data requestor 402 either directly or by way of the internal poller 403.

In use, the central data management system 330, just as the central data management system 30 previously described herein, receives and stores data in the central storage system 130 and the secondary systems 30′ and 30″. The data may comprise, for example, an image from a local image workstation, associated patient information, review history from remote or local sites, radiologist or physician notes, text, voiceovers, comment, remote or local history records, diagnostic, treatment or other information relating to a patient's medical record. The data is also stored in the data queue 231 as illustrated in FIG. 7 (301).

The data is then pushed or delivered to the destination(s) based on information in a look-up-table 232 where the look up table 232 contains a last known IP address associated with each location 302. Push technology where information is sent to a predetermined address, is generally known in the art.

The remote module 40 then provides a confirmation as to whether or not delivery is completed 303. (The preferred embodiment is described with respect to the remote module 40, although the module at the delivery destination may be a local or remote workstation, image viewer or other interface.) If delivery is complete, the delivery status database 233 and the central history file record are updated to indicate delivery status as completed, including the time of delivery (304). The delivered data file is then removed from the queue 231.

If the delivery is not successful, then the delivery status database 233 is updated to indicate delivery failure (305). The central data management system 330 then waits until IP notifier/data requestor 402 of the remote module 40 requests queued data (306) and/or updates the IP address in the look up table 232. When the request is received, that data is delivered to the IP address in the updated look up table 232 (307). This cycle is repeated until there is a successful delivery. As part of the delivery status database 233, certain files that are not delivered by a certain time may be brought to the attention of a system administrator, preferably of the data origin.

FIG. 8 illustrates the use of the polling system 400 described with respect to FIGS. 7-10 in use with the remote module or workstation 40. The remote module 40 establishes an Internet connection (310). The remote module 40 connects to the central data management system 330 (311). In this regard, the connection between the remote module 40 and the central data management system 330 may be established, for example, by way of a static or dedicated IP address, a floating IP address, or as otherwise provided by an Internet service. The remote module 40 checks its IP address by way of software within the connection status monitor 401 that monitors the connection status and determines the module's IP address (312). The steps described are not necessarily performed in this order. For example, they may be reversed.

After determining the remote module's IP address, the IP address look up table 232 of the central data management system is updated 313. This may be accomplished a number of ways. In preferred embodiments, the connection status monitor device 401 provides the updated IP address information to the IP notifier/data requestor 402 either directly or indirectly through the internal poller 403. Through internal software, the IP notifier/data requestor 402 sends a signal to the look up table 232 with updated IP address information.

The local module then requests any data that may have been stored in the delivery queue 231 (for example, while the local module was offline) (314). The request is made by the IP notifier/data requestor 402 that has been instructed either by the connection status monitor 401 or the internal poller 403 to request queued data as described above.

If queued data is present (315), the data is delivered from the delivery queue 233 by way of the updated IP address stored in the look up table 232. Alternatively, if the central data management system does not have an IP address look-up table for the purpose of data deliver, the IP address from which the data request is sent, will be used to deliver the data. The data is accepted by the remote module 40 (316). Then the remote module 40 waits for an event (317). If data is not present, (315), the remote module 40 continues to wait for an event (317). The poll event may be, for example, the end of a preset interval of time, and/or another event such as booting, rebooting, connecting to Internet, reconnecting to the Internet, or detecting a reassigned IP session number.

If the push system is being used, while waiting for the poll event, any data received by the central data management system that is to be delivered to this module may be pushed to the module in a manner such as that described above.

When a poll event has occurred such as the end of a poll interval, the system checks the IP connection status (318). If the status has not changed, then the system awaits requests queued data and continues from 314. Alternatively, when the push system is used, because the connection status has not changed and the IP address located in the look-up table is the current IP address, the system instead of requesting queued data, may just continue to wait for the next polling event, i.e., return to 317 and the central data management system will send the data as it is received.

If the status has changed (319), and there is no internet connection (320), then the module is instructed to reestablish an internet connection (returning to 310). If there is an internet connection, (320) then the software instructs the connection status monitor to check to see if there is a connection with the central data management system 330 (321). If there is no connection to the central data management system then the software instructs the system to make a connection to the central data management system, returning to step 311. If there is a database connection, then the software instructs the connection status monitor 401 to determine if the IP address has changed (322). If the IP address has changed, then the a signal is sent to the central data management system 330 to update the look up table 232 with the new IP address the cycle continues at step 313. If the IP address has not changed, there is a request for queued data and the cycle continues from step 314.

The invention described above may take various forms or may be accomplished in a variety of manners. The polling system may comprise numerous software and or hardware configurations that will accomplish the described invention and are contemplated to be within the scope of the invention. The polling system may be used alone or in conjunction with a push system as described above. Other events may trigger the poll request depending on the configuration or specific needs of the viewing system (remote or local).

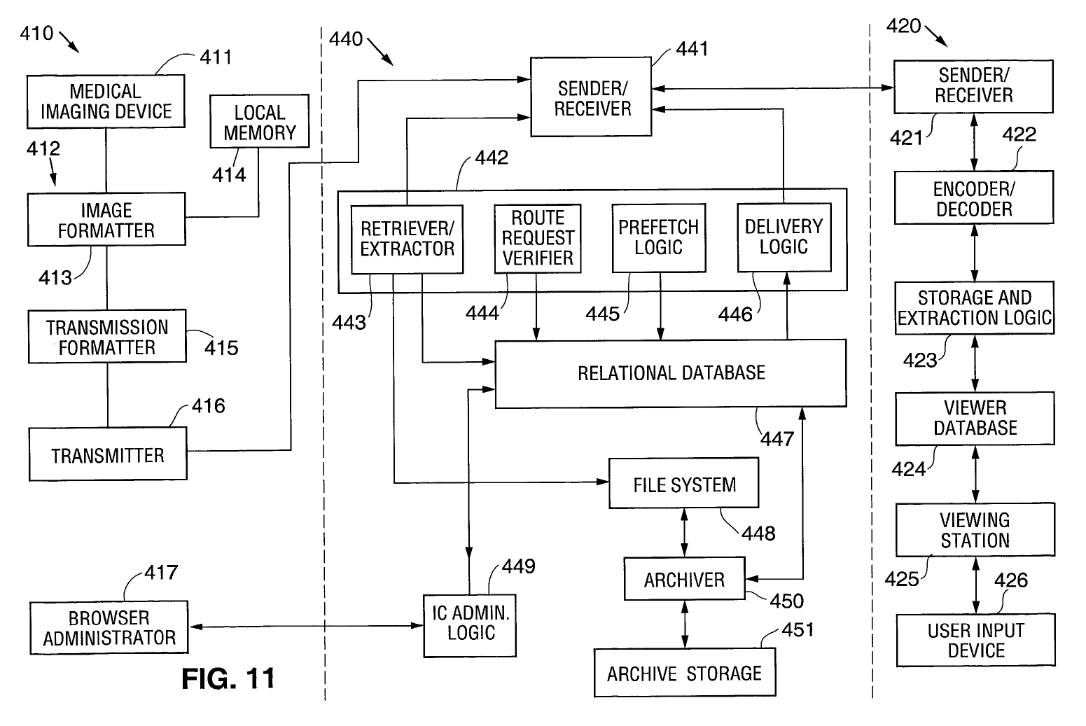

Referring to FIGS. 11-21 an alternative embodiment of the medical image management system is illustrated. The system 410 which is typically at an imaging center comprises a local medical imaging device 411 with a local workstation 412; a data center 440; and a remote viewer 420.

The local imaging device 411 is coupled to an image formatter 413 that is operative to format an image into an image file in a standardized machine-readable format. The image formatter 413 is included with the local workstation 412 except where the medical imaging device is already arranged to format the image to such a standard. Preferably the image format is the DICOM format. Once formatted, the image file may be stored in a local memory 414. The image formatter 413 is coupled to a transmission formatter 415, which creates a message in a transmission protocol to which the image file is attached. In one preferred embodiment, the transmission format is an e-mail format. Alternatively, the transmission formatter may use another transmission protocol such as a XML or wireless message with the image file as an attachment. In a preferred embodiment, the transmission formatter 413 creates an e-mail having a header with transmission information and an image file attached to the email. The image file is MIME encoded and the e-mail is transmitted to the data center 440 through the transmitter 416 by a secure transmission such as SSL. Socket Tools and IP*Works are examples of software programs that provide SSL. This is also provided at the viewer. The e-mail header includes “to” and “from” lines that are addressed to the data center and from the local workstation 412. Also a subject line contains information regarding the type of message. In the case of an image from a local workstation 412, the e-mail is addressed to the data center and the subject line indicates that the attachment is a DICOM formatted file. Other subject lines may identify attachments. The subject line may also contain status information, e.g., “image received” or “study viewed” for a particular image or study.

The local workstation 412 also includes a browser/administrator 417, e.g., a telnet or http session that communicates with an administrative component of the data center 440 to access tracking and administrative information from a relational database 447 at the data center 440. The administrative logic 449 permits the browser/administrator 417 at the workstation 412 to revise incorrect routing information corresponding to image files originating from the workstation 412. The browser/administrator 417 also permits the administrator at the local workstation 412 to view the delivery and viewing status of the image files sent to the data center 440. The imaging center administrative logic allows viewing of route requests and tracking statuses; resolution of ambiguous route request destinations; resubmission of requests, e.g., if patient preferences have changed; data maintenance on user patient and IC preference tables, and the running of reports.

The data center 440 includes a sender/receiver 441 for sending and receiving messages. In a preferred embodiment, the sender/receiver 441 is a mail server (preferably an SMTP/POP3 server) arranged to send and receive messages having an e-mail format. Alternatively, the sender/receiver 441 may be an XML, FTP, HTTP, etc. transaction engine. As illustrated in FIG. 11, the sender/receiver 441 sends and receives messages to and from the local workstation transmitter and the sender/receiver 421 of the remote viewer 420. The sender/receiver 441 sets up a mailbox for each user at each of the user's assigned locations. When messages are ready to be transmitted, they are placed in the mailbox and the sender/receiver 441 awaits a poll request from the mail client at the viewer. Upon receiving a poll request, the sender/receiver 441 transmits messages stored for collection by the particular user location.

The data center 440 includes programmed logic 442 operative to forward messages with a file or other attachments, and related files and information, to the appropriate remote viewers, to track the delivery and viewing of the files or other attachments, and to store the files, other attachments and tracking information in a relational database and filesystem.. The image files and any overlays or subsequent attachments, changes or additions, are stored in the file system 448 of the data center 440. Information concerning the file, its history, its location in the filesystem 448 and the location of related attachments, are organized and stored in a relational database 447. The mail is only deleted from the mailbox when it has been successfully stored in the database. An archiver 450 is arranged to archive the files in the filesystem 448 in archive storage 451 according to a predetermined storage protocol. The archiver 450 looks to the relational database 447 to determine which files have not been archived. The files not archived are copied from the file system 448 and are archived. The data center 440 also includes administrative logic 449 configured to access tracking information in the relational database 447 and to permit a local workstation administrator to revise unverified route requests upon appropriate security clearance.

The programmed logic 442 includes a retriever/extractor 443 that checks the sender/receiver 441 for new messages. The retriever/extractor 443 effectively logs into the mail server like a regular user but with the name of a mailbox designated to receive messages from the local image workstation 412 or viewer. The retriever extractor 443 then extracts key information from the attached file, stores the file in the filesystem 448, and stores the key information and filesystem location information in the relational database 447. Among other things the retriever extractor marks the file with routing requests to be verified.

The programmed logic 442 also includes a route request verifier 444. After the message attached to the file has been saved and the route request marked, the route request verifier identifies the route request and verifies that the route is valid. If it is, then the file is marked for delivery. If not, the file is marked as needing administrative review.

The programmed logic 442 also includes prefetch logic 445 that identifies files related to the file to be routed, for example, earlier images, other patient information, reports, overlays, annotations, etc., associated with a study. The prefetch logic 445 marks the identified files for delivery, executes a route request and verifies it automatically. A user or viewer may be provided with a browser to identify or fetch films they would like to see.

The programmed logic 442 further includes delivery logic that identifies the files marked for delivery and submits them to the sender/receiver 441 for attachment to a message and delivery to the appropriate viewer.

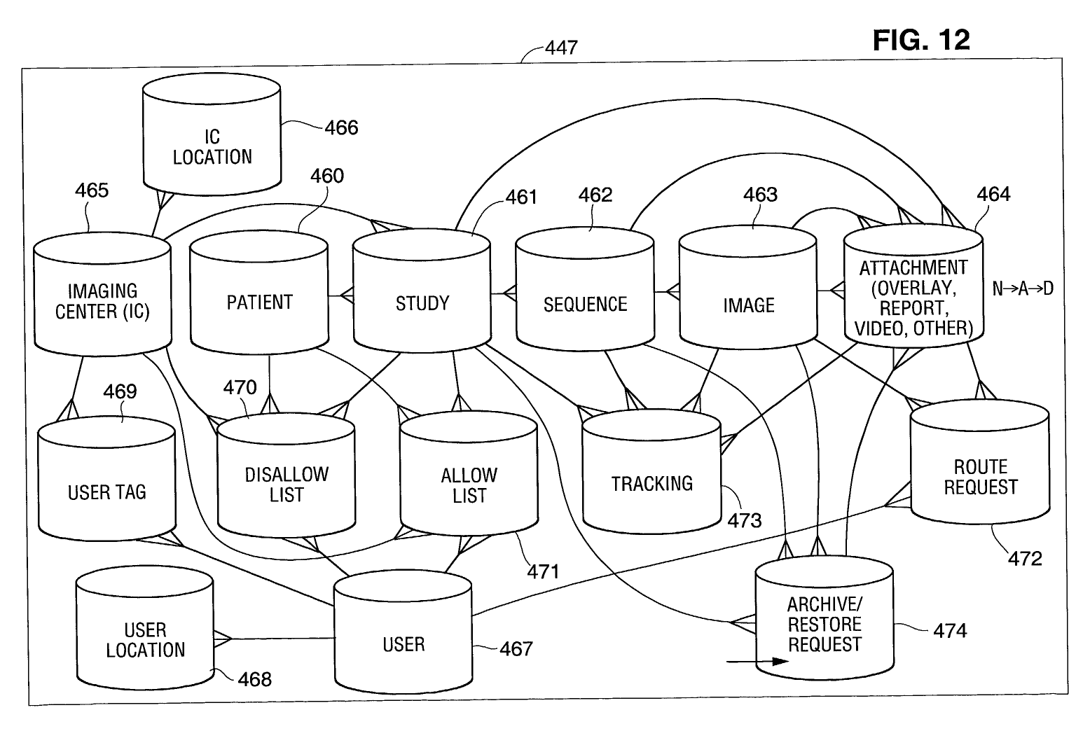

The relational database 447 illustrated in FIG. 12 shows the primary elements of the relational database 447 to be maintained at the data center 440. The relational database may be implemented, for example, using an Oracle database system. Lines with “crows feet” refer to the relationship that one element has with another, namely that the element with a straight line is the “master” of the one with the crows feet (the “slave”); one master record exists for zero or more slave records. For example a patient can have zero or more studies, and a study can have zero or more sequences.

Most information is related to the patient data 460. Patient data 460 includes a list of patients and other patient identifying information. A patient can have any number of studies 461, each of which can have any number of sequences 462, each of which can have any number of images 463, each of which can have any number of attachments 464 such as overlays, reports,, video, voice, or other attachments.

Route Requests 472 are held for each of the images 463 and attachments 464. By virtue of the image's and attachments' relationships with the patient, study and sequence, route requests 472 are accordingly related to each of the patients 460, studies 461 and sequences 462.

Tracking data 473 data is related to images 463, sequences 462 and studies 461.

Disallow and Allow lists, 470 and 471 respectively are the means by which authorization is determined, i.e., it includes lists of where given studies, sequences and/or images are allowed to go. For a given patient, any number of records can be held denoting a combination of study 461, imaging center 465 and professional user 467. A record in the disallow list 470 indicates that this study from this imaging center is not forwarded to the given user. The same record in the allow list 471 allows the forward. Combinations of entries can provide any configuration of authorization a patient may devise. These preferences are entered by Imaging Center (IC) technicians using their front-end administration tool.

The user files 467 includes a list of individuals who operate viewer. Users 467 and imaging centers 465 can both have any number of locations 468, 466 respectively. Users 468 can have files submitted to multiple locations and Imaging Centers can have any number of tech stations and front desk stations. User preferences are stored in the user database 468. The preferences may include when to send the file, e.g. after reviewed by radiologist, or which key images to send, etc. The User 467 may be given the ability to change preferences, e.g., when to send where, which days to send which images and which user location. Users may have a number of User Tags 469 used to address the User at one or more locations. The Tag 469 includes a list of each of the different ways to refer to each user. A User may use different names at different imaging centers. A Tag may be related to a particular image center.

The Archive Restore Request 474 is related to study 461, sequence 462, image 463 and attachment 464. The archive logic determines when to archive an object and copy it from online storage to offline storage. This is done by placing an archive request in the archive/restore request table 474. When this occurs, the database records are marked as “archived”. At this point, duplicate copies exist in archive and on the filesystem. The archive logic also determines when to delete the archived file from the file system. The file or object is then marked “deleted” meaning that the file or object is archived but not in the filesystem. When a file has been deleted, it may be restored by listing the restore request for the object in the archive/restore request table. The archive logic will check the table and fetch the file or object from archive and save it in the filesystem. The restored status will be noted in the tracking database 473 against the object (i.e. image or attachment) stored.

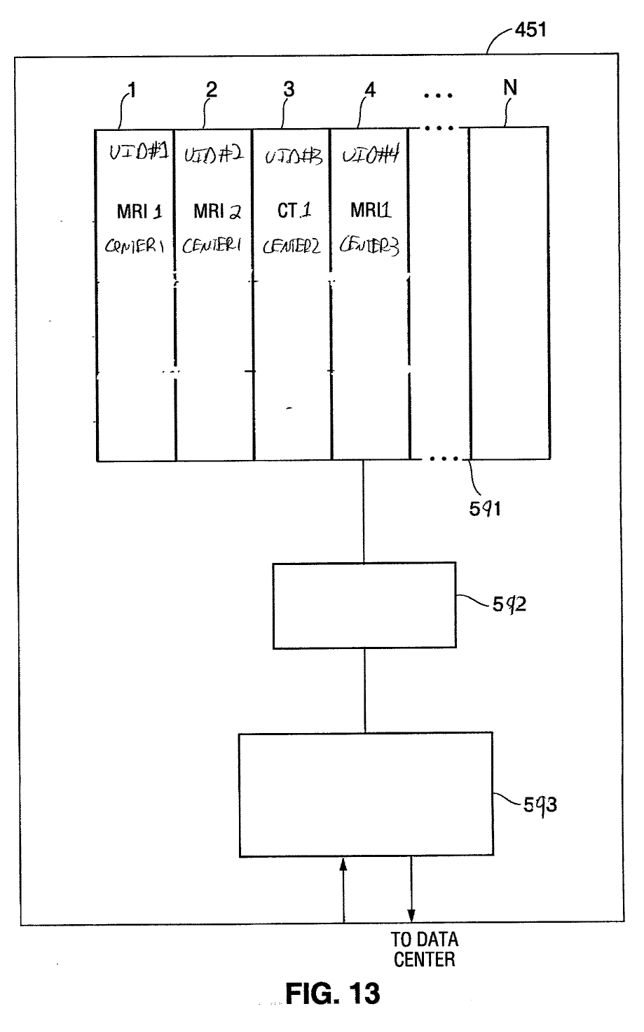

Referring now to FIG. 13 the archive 451 is illustrated where digital image files and attachments (e.g. overlays, reports, etc.) may be kept in association with the data center for lifetime storage of image files. The archive 451 is preferably an offsite storage system that includes a mechanical tape storage device 591, a mechanical device 592 for accessing and moving the tapes to a storage control and reading device 593. The storage control and reading device is coupled to the data center archiver that controls the archiving functions of the data center. The tape storage device 591 holds tapes 1 to n. Each tape has a unique identifier stored in the archive restore request database 474 that also identifies the imaging machine at a particular study center, and the imaging modality, e.g. MRI, CT, Ultrasound, etc. For example, tape 1 has a unique identifier (“UID”) No. 1 that corresponds to MRI number 1 at imaging center 1. Tape 2 has a UID 2 that corresponds to MRI 2 ant center 1, Tape 3 has a UID 3 that corresponds to CT1 and imaging center 2, and tape 4 has a UID4 that corresponds to MRI machine 1 at center 2. The archive 451 will receive a request from the archiver 450 at the data center 440 for an archived file. The location of the archived file's tape (identified by its UID) is stored in the Archive/Restore Request database 474 within the relational database 447. The storage control and reading device 593 will direct the mechanical device 592 to retrieve the tape from its storage location in the storage device 591and place the tape in the reader 593 where the appropriate image file is transmitted to the central database 440 through the archiver 450. The image file is then routed at the data center 440 in a manner as described herein.

As illustrated in FIG. 12, a preferred embodiment of a viewer 420 comprises a sender/receiver 421 for sending and receiving messages. In a preferred embodiment, the sender/receiver 421 acts as a mail client. The sender/receiver 421 includes a polling device that polls the data center for messages ready for delivery, typically at predetermined time intervals. In a preferred embodiment, the viewer periodically checks e-mail at a designated POP server at the data center 440 for incoming mail. The viewer processes incoming e-mails and sends out status emails using SMTP back to the data center 440. The sender/receiver 421 is coupled to an encoder/decoder 422 that decodes received messages that have been formatted for delivery in the transmission format, and encodes files for attaching to messages to be sent. When the message is received and decoded, the storage and extraction logic 423 stores the image file in the viewer database 424 which includes a relational database, and extracts key information from the image file and saves it in the relational database. The relational database may, for example, organize the images based on patient, study, sequence and image. Information relating to the exam may be stored such as, for example, the referring physician, the date, the image center, the procedure, etc. Various image information may be included as well, such as size, image type, height, width, orientation, position, etc.

A user at the viewing station 425 may open the files stored in the viewer database 424 that are awaiting the user when the user needs the file. The files are accessible through the relational database such as an Access™ database. A user input device 426 allows a user to select files at the viewing station 425 and view the images 482 and manipulate the images 483 using various applications as desired. The user input device 426 also permits creating attachments such as overlays (marks on images typically placed on images by radiologists or other physicians), voice, text video, or other attachments to the viewed files, which may be forwarded to other users or stored through the data center 440.

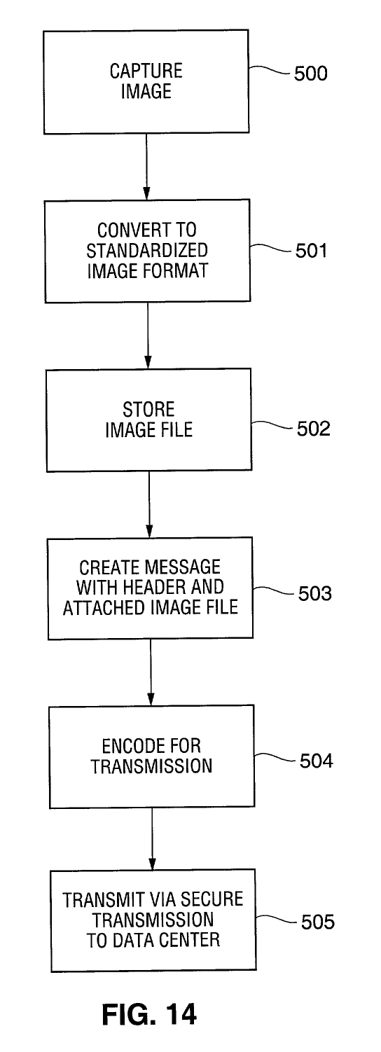

FIG. 14 illustrates the flow of data through the local workstation in a preferred embodiment of the invention. The medical imaging device 411 captures an image or a sequence of images forming a study 500. The image or images are converted to at standardized image format 501. In the preferred embodiment the image format is the DICOM format. The DICOM format includes image data and other information such as imaging center, referring physician, radiologist, patient, image information, sequence information study information, etc.

The image file is then stored 502 in local memory 414. A message is created 503 using a standard transmission format with a header containing delivery information and identification of the type of attachment, i.e., in this case, an image file. In the preferred embodiment, the transmission standard is an e-mail standard. The header contains the address line addressed to the data center and the from line identifies the imaging center. In general in the system of the invention, the subject line describes the type of attachment or provides status information and the content contains the attachment, or in the case of a status message, is empty. The e-mail message when delivering images from the imaging center will identify the attachment as an image and will attach the image as the content.

The message is then encoded for transmission 504. In the preferred embodiment the DICOM image file is MIME encoded for internet e-mail transmission. Other formats are contemplated by this invention such as UUENCODE. The MIME encoded message is then transmitted via a secure transmission to the data center 505. In one embodiment the secure transmission uses SSL.

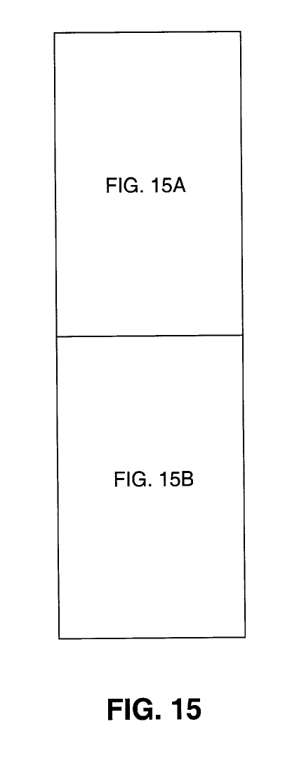

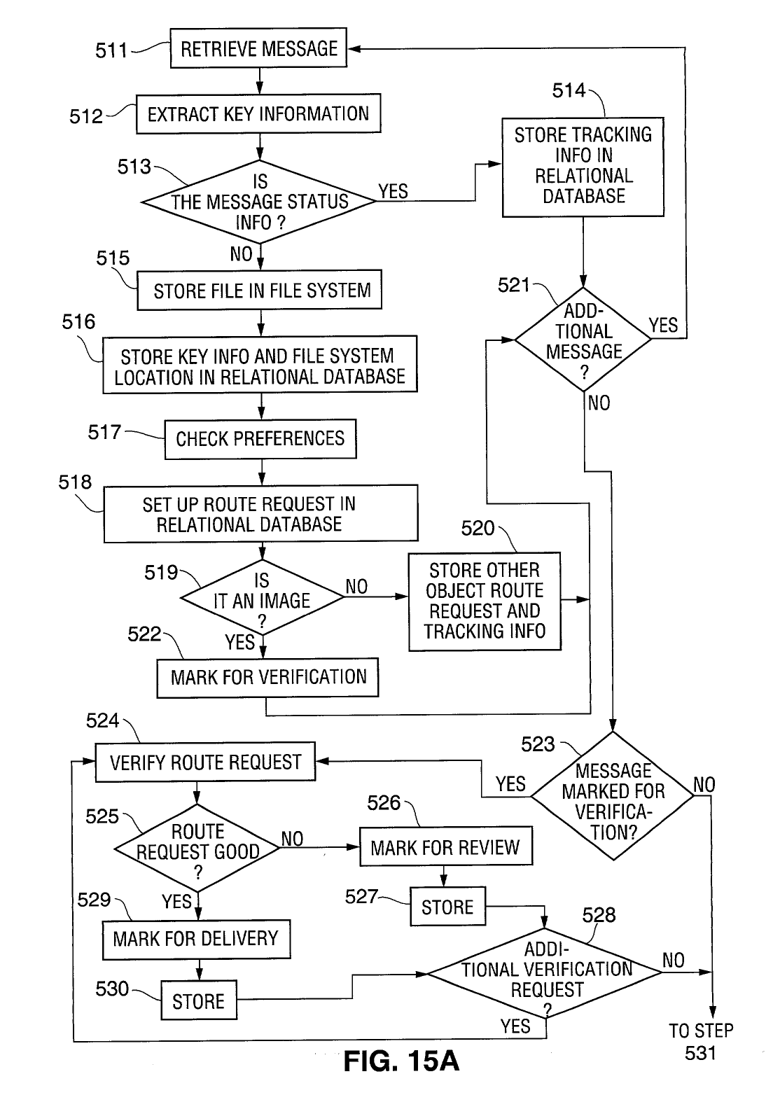

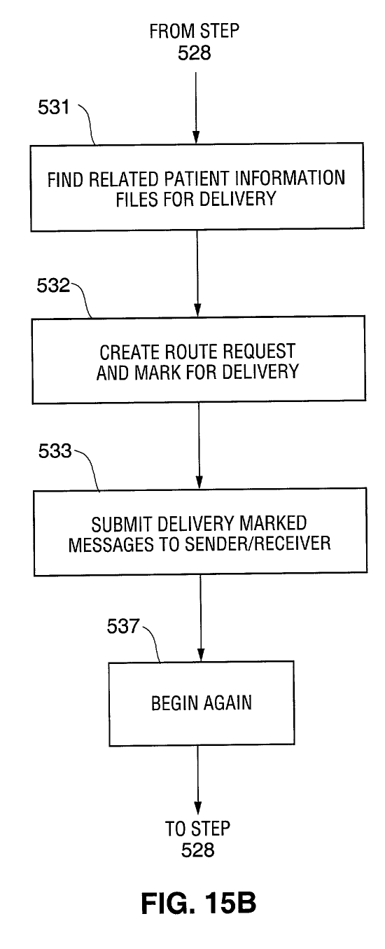

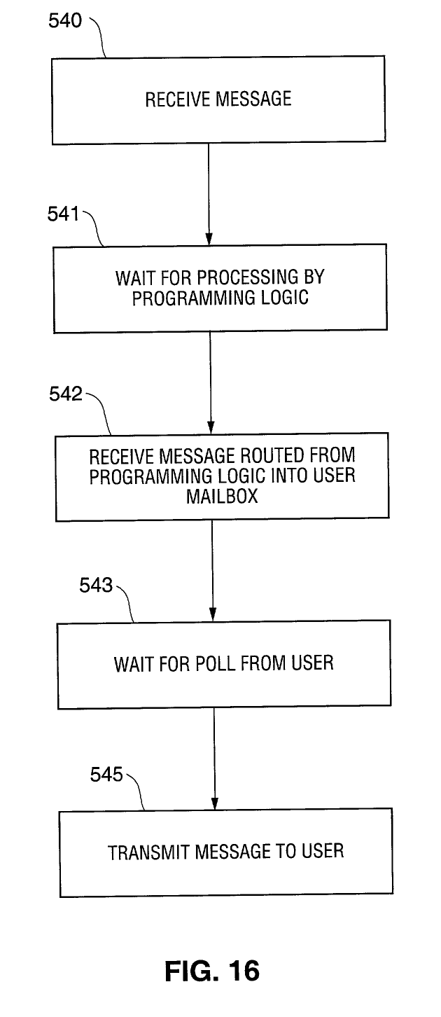

FIGS. 15 and 16 are flow charts illustrating a preferred use of the data center 440 to route, store and track images and related information. A message is received 540 by the sender/receiver 441, preferably a mail server. The message may be an image from the local workstation 412, a report from a radiologist, an overlay from a radiologist, physician, or other user, voice, text or other attachment, or a status message indicating tracking information. The sender receiver 441 waits for the programming logic 442 to process the message 541. The retriever/extractor 443 periodically checks to see if messages have been received. When a message has been received, it retrieves the message 511 and extracts key information from the image file 512 and the transmission header. If the message is status information 513 then the status information is stored 514 in the tracking file 473 in the relational database 447. If there are any additional messages 521 the retriever/extractor 443 will repeat the retrieving extracting steps until there are no more messages waiting. If the message is not status information 513, the message attachment is stored 515 in the file system 448. The extracted key information and the file system location are stored 516 in the appropriate locations in the relational database 447. The retriever/extractor 443 also checks the user and location preferences 517 e.g., delivery location, timing, specification of which images, requests to send only if report exists, etc. The retriever/extractor 443 also sets up a route request 518 based on destinations and users that is stored in the route request table 472 or the relational database 447.

If the file attached to the message is anything other than an image file 519, the message is marked for delivery and tracking information is stored 520. If there are any additional messages 521, the messages are retrieved and the retrieval extraction steps are repeated. If the attached file is an image 519 it is marked for verification 522. After that the logic checks to see if there are any additional messages 521. If there are any additional messages 521, the messages are retrieved 511 and the retrieval extraction steps are repeated.

After the received messages have been retrieved, the route request verifier 444 checks for any messages marked for verification 523. If not, the programmable logic moves on to the pre-fetch logic 445. If messages are marked for verification 523 then the route request verifier 444 first checks whether the specified user is in the User Tag list 469. Then the route request verifier determines whether the user 467 and study 461 are on the allow or disallow list 471, 470 for a patient 460 and/or imaging center 465. If the route request is not valid 525 then the route request is marked for review 526. The route request is stored 527 and the logic looks for additional verification requests 528. If there are additional verification request the verification steps are followed again. If not, then the programmable logic 442 moves on to the pre-fetch logic 445.

If the route request is good 525, then the file is marked for delivery by flagging the route request 529. The delivery flag is then stored in the route request database 530. Additional verification requests are then processed 528 until no further verification requests are in the route request file at which time the programmable logic 442 move on to the pre-fetch logic 445.

The pre-fetch logic 445 finds related patient information files for delivery 531. In doing so, the logic may check user or location preferences. Once the related files for delivery are identified, the pre-fetch logic 445 creates a route request and marks the file for delivery 532. The delivery logic then finds files marked for delivery and submits them to the sender/receiver 533. The programmed logic 442 begins its process again 537, typically after a predetermined period of time. When the programmed logic is not running, the data center 440 may run the archiving logic at the archiver 450.

The sender/receiver 441 receives the routed message 542 and waits for a poll request 543 from the viewer 420 before transmitting the message 545. The message using standard e-mail protocol is then able to go through most firewalls.

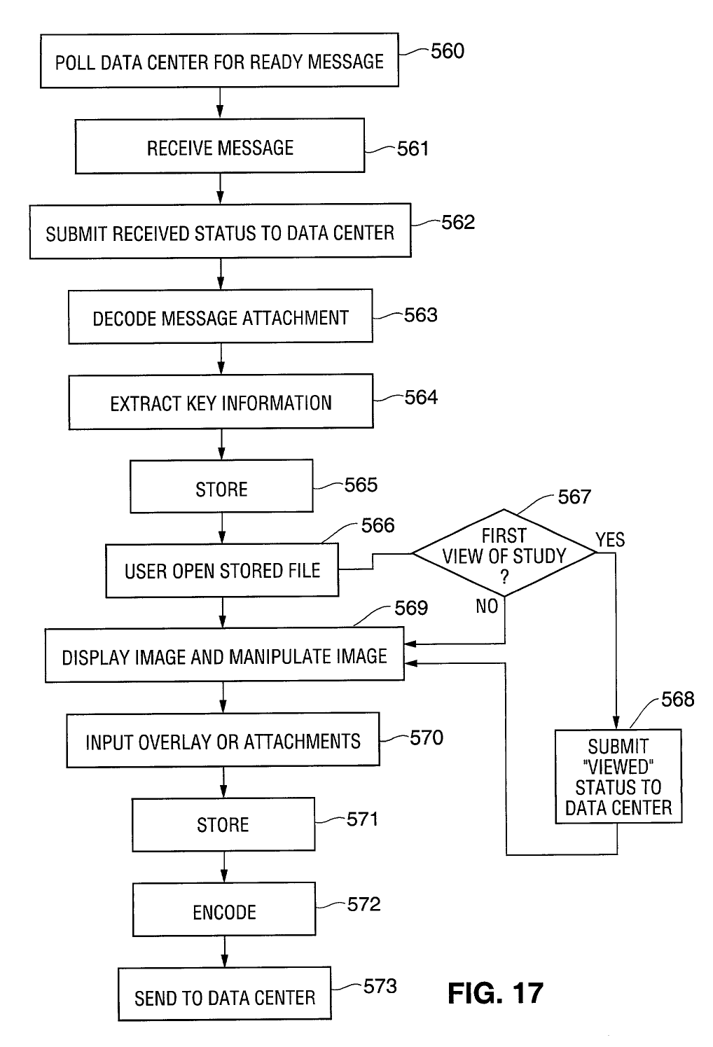

FIG. 17 illustrates the flow of data in the viewer 420. The viewer sender/receiver 421 includes a poller that polls the data center for ready messages 560. Typically the polling will occur at predetermined intervals or when an event has occurred such as logging in. The sender/receiver 421 then receives the message 561 and submits a received status to the data center 562. In a preferred embodiment the sender receiver 421 is a mail client, which polls the mail server for mail. The mail is sent using e-mail standard protocols, e.g. using POP3. The sender/receiver 421 sends back a confirmation that it has received each image. The attachment to the e-mail is decoded 563 so that it is in a machine-readable image format and the key information is extracted 564. The file and the key information are stored 565 and the user can access the file as it is organized in its own database. When the user is ready to review the images, the user opens the stored file 566 at the viewer 425. If it is the first viewing of the study 567 then a status message is sent to the data center that the study has been viewed 568. The image is displayed 569 when the user opens the stored file. The user may manipulate the images using various applications, preferably available at the viewer. The user may input any overlay or attachments 570 through the user input device 426. Any input of overlays or attachments are first stored in memory 571 and then are encoded 572 to be delivered via a message. The files are then submitted to the sender/receiver 421, which transmits the message to the data center 573.

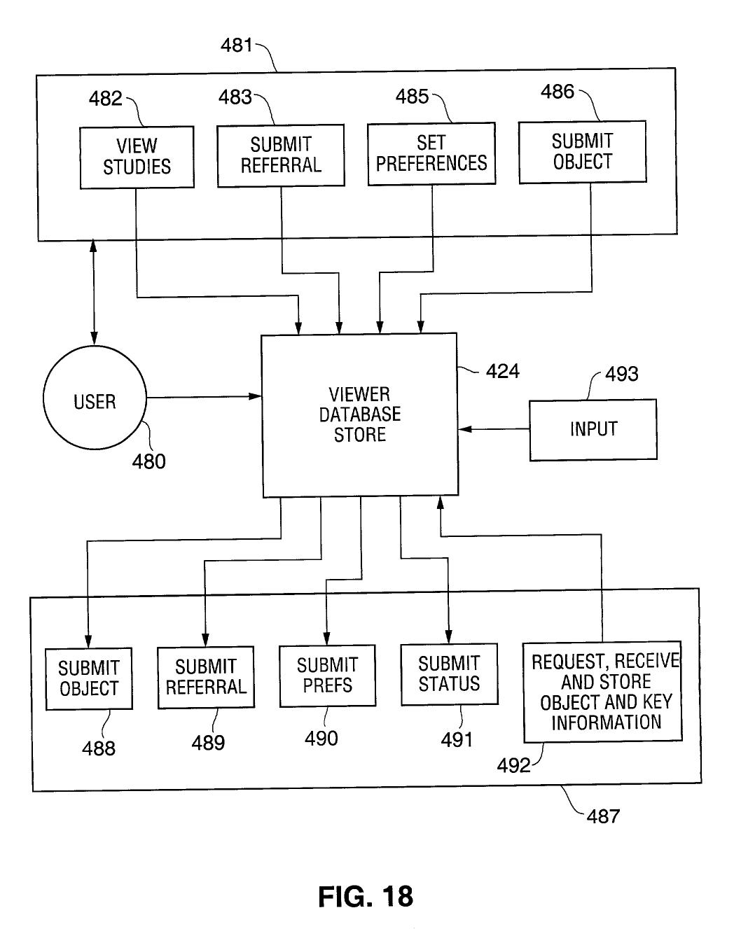

FIG. 18 is a schematic of the background and foreground processes of the viewer 420. In the foreground 481, a user interfaces with the viewing station 425 to view studies 482, manipulate the image files 483, submit referrals 484, set preferences 485 for viewing and receiving messages, and to submit objects 486 such as overlays voice, text, or other attachments. These processes are done with the user involved or observing. The actions either access information from the viewer data storage 424 or submit information to be transmitted to the data center and other viewers or imaging centers. This information is submitted by a user, is stored in data storage, and is submitted to the data center using background processes 487 not viewed by the user. The objects submission messages 488, referral messages 489, preference messages 490, and status messages 491 are generated by the viewer and are submitted to the data center according to transmission protocol, preferably an e-mail protocol. In addition, in the background 487, the viewer 420 is periodically polling the data center 440 for ready messages, is receiving those messages, extracting key information and storing the image files and key information 492 in the data storage 424 for viewing by the user 480 when the user 480 is ready to view the images. Thus, the user 480 is not required to login to retrieve image files. The image files are essentially waiting for the user when the user seeks to view them.

The viewer is also provided with the ability to request the data center download all or a part of the files designated for the viewer. For example, the viewer may request a download of all the files for a particular month. In such embodiment, the viewer is provided with administrative abilities, for example, using a browser similar to the imaging center's browser. The viewer may also use its own database to store files and use the data center as a back up.

The viewer is also provided with alternative systems to import, package and store data compatible with the packaging and storage of the image files. Accordingly, an input 493 is coupled to the viewer database store 424. The input 493 may be coupled to a data input device such as a physical medium, e.g. a CD-ROM driver, floppy, ZIP drive or local network drive, etc., a scanner for scanning text or images, or the output of an imaging device, e.g., digital camera, etc. The input allows inputting of files to be associated with a patient or study. The user 480 may input key information into the viewer database store 424 to be associated for example with a patient study. The key information is stored in a relational database and is associated with the input data in a manner similar to the key information associated with an image or study that is transmitted to the database from the data center. Accordingly, the input file may be packaged and delivered through the data center in a manner similar to overlays, etc. as described herein.

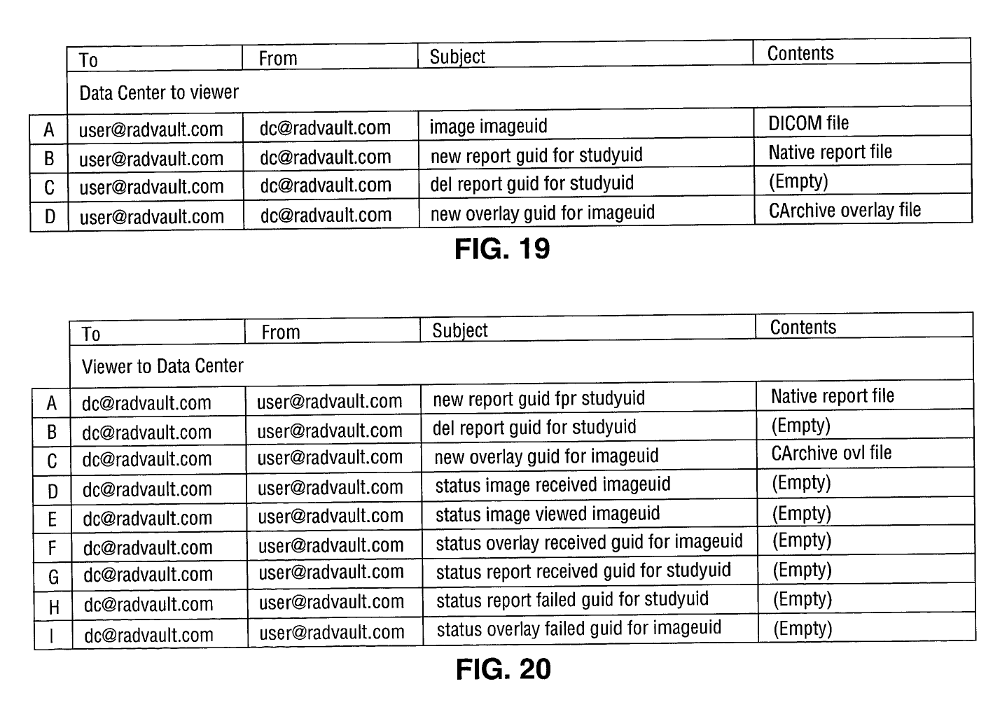

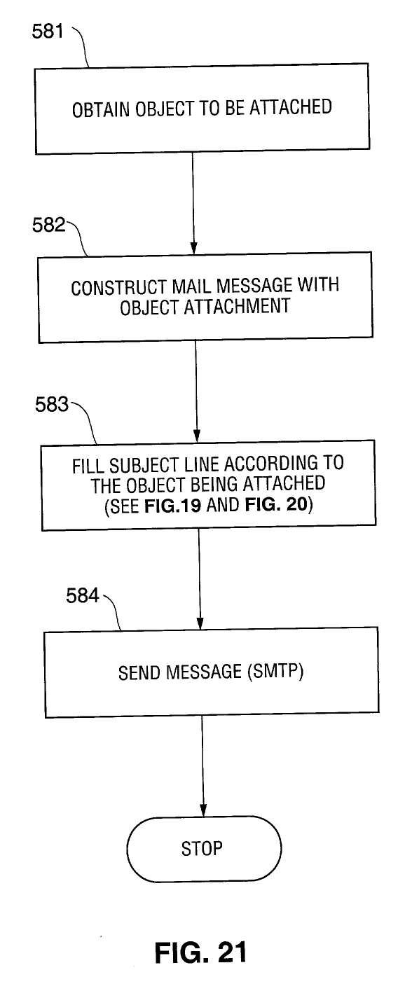

FIG. 19 illustrates examples of packaging image files for transmission. Messages A-D have headers, (in this case, including “To:. From:, and Subject:” portions) used to transmit image files, attachments, and status messages from the data center. The “TO:” line is the address of the viewer or viewers approved to receive the message. The “From:” line indicates the data center address. The “Subject:” line provides identifying information that identifies the type of file or status message and identifies the particular image, study, or other parameter with which the attachment or message is associated. For example, message A indicates that the attachment is an image(“image”). The header also contains the image unique identification number (“imageuid”) which is a unique number assigned to the particular image attached. In this particular embodiment “imageuid” is extracted from the DICOM image file and placed in the header when the transmission message is created at the imaging center. The message is then transmitted to the data center. The data center routes the message to the viewer as described herein, using the header. The “Contents” in message A is a DICOM image file attached to the message. Message B's subject line indicates that the attachment is a report (“report”). A global unique identifier (“guid”) is generated corresponding to the report. Software is available, for example, from Microsoft, that allows the generation of a global unique identifier. The global unique identifier is included in the header along with the study unique identifier (“studyuid”), which has been extracted from the DICOM file. The “studyiud” is one portion of identifying information provided as part of the DICOM image file. This information is extracted from the image file at the viewer where a report is created, typically by a radiologist when viewing the study. The viewer automatically creates a header for the report that includes the studyiud that has been extracted form the DICOM file. The “Contents” in message B is the native report file. Message C is a status message indicating that the report identified in the subject line by report guid and associated studyiud should be deleted (“del”). The “Contents” in message C is empty since the information of the status message is contained in the subject line. Message D indicates that the attachment to the message is an overlay (“overlay”) that has a “guid” and is associated with an image identified by the imageuid. At the viewer a global unique identifier for the overlay is created and the guid is placed in the header. The overlay corresponds to a particular image that is open when the overlay is created. The image unique identifier, “imageuid”, is extracted from the DICOM file at least when the image is originally packaged. The image and associated information is stored in the relational database at the data center and the image is routed to authorized recipients. Because the DICOM file contains the identifying information including the imageuid and the studyuid, the data center and viewers may be programmed either to extract the information from the image file or use the information extracted from the image file that is placed in the header of the original message from the imaging center. In either case extracted identifying information is used in the message header. The “Contents” in message D is the actual CArchive overlay file.

FIG. 20 illustrates examples of headers used to transmit image files, attachments and status messages from the viewer. The “To:” line indicates the data center address to which the message is sent. The “From:” line is the address of the viewer or viewers transmitting the message. The “Subject:” line identifies the type of file or status message. Message A indicates that the attachment is a report and includes other identifying information including the report “guid” and the associated “studyuid” obtained from at least one image of the study opened when the report is initially created. The “Contents” in message A is a native file report. Message B is a status message indicating that the report identified by the guid and corresponding studyuid should be deleted. The “Contents” in message B is empty since the information of the status message is contained in the subject line. Message C indicates that the attachment is an overlay. The overlay is created with an image file open and when the overlay is attached to the message, the associated image file unique identifier imaguid is placed in the header. The “Contents” in message C is an overlay file in Carchive. Message D is a status message indicating that a particular image identified by imaguid, has been received by the viewer. Message E is a status message indicating that the study identified by studyuid, has been viewed. When an image from a study is opened, the studyuid that has been extracted from the DICOM file and placed in the header of the status message. Message F is a status message indicating that a particular overlay identified by overlay guid and imagiud,has been received. Message G is a status message indicating that the report identified by report guid and studyguid has been received by the viewer. Message H is a status message indicating that a particular report that was delivered, failed, for example because the corresponding studyuid is not available to the viewer or was not delivered. Message I is a status message indicating that a particular overlay identified by guid an imageuid, that was delivered, has failed, for example, because the corresponding image was not available at the viewer or was not delivered to the viewer. The “Contents” in messages D-I are empty since the information of the status messages are contained in the corresponding subject lines.

Referring now to FIG. 21, an example of a packaging system for packaging an object in a package such as a message is illustrated. An example of an object to be packaged includes, for example, a DICOM image file, an overlay annotation to be associated or related with a particular image; a voice annotation to be associated with, e.g., a patient study or image; a video clip, a digitized photo, etc. The object to be attached is obtained 581. A mail message is constructed with the object as an attachment 582. Using the unique identifiers generated or extracted from an associated DICOM file and identification of object type, as illustrated in FIGS. 19 and 20, a subject line is constructed 583. The message is then transmitted using SMTP 584 using secured transmission such as SSL.

The invention described above may take various forms or may be accomplished in a variety of manners that will accomplish the described invention and are contemplated to be within the scope of the invention as claimed herein.

What is claimed is:

1. A medical image electronic package for an object relating to an electronic image comprising:
a message including a header and an object file attached to said message,
said object file comprising an electronic file relating to an image and identifying information uniquely identifying the electronic image,
said header comprising a destination identifier, an origination identifier and an attachment identifier, wherein said attachment identifier comprises an object type identifier configured to identify the type of object file attached to said message and a portion of said identifying information, wherein said portion of said identifying information is extracted from said object file.

2. The medical image electronic package of claim 1 wherein said object file comprises DICOM image file and wherein said identifying information comprises an image unique identifier, and wherein said portion of said identifying information comprises said image unique identifier.

3. The medical image electronic package of claim 1 wherein said object file comprises an overlay annotation file and wherein said identifying information comprises an image unique identifier corresponding to an image file associated with said overlay annotation file, and wherein said portion of said identifying information comprises a unique overlay file identifier and said image unique identifier corresponding to said image file associated with said overlay annotation file.

4. The medical image electronic package of claim 1 wherein said image forms at least in part a study, wherein said object file comprises a report associated with the study and wherein said identifying information comprises an study unique identifier corresponding to an study associated with said report, and wherein said portion of said identifying information comprises a unique report identifier and said study unique identifier corresponding to said study associated with said report.

5. The medical image electronic package of claim 1 wherein said message is formatted for transmission by SMTP.

6. A packaging system for electronically packaging an object file relating to an electronic image file wherein the electronic image file includes identifying information uniquely identifying the image file, said packaging system comprising:
a message generator for generating a message to be transmitted,
wherein said message generator is configured to attach the object to the message for transmission,
said message generator comprising a header generator wherein said header generator is arranged to generate an attachment identifier including an object identifier identifying the type of object attached to the message and a unique identifier comprising a portion of the identifying information uniquely identifying the image file.

7. The package system of claim 6 wherein said object file comprises DICOM image file and wherein said identifying information comprises an image unique identifier, and wherein said portion of said identifying information comprises said image unique identifier.

8. The package system of claim 6 wherein said object file comprises an overlay annotation file and wherein said identifying information comprises an image unique identifier corresponding to an image file associated with said overlay annotation file, and wherein said portion of said identifying information comprises a unique overlay file identifier and said image unique identifier corresponding to said image file associated with said overlay annotation file.

9. The package system of claim 6 wherein said image forms at least in part a study, wherein said object file comprises a report associated with the study and wherein said identifying information comprises an study unique identifier corresponding to an study associated with said report, and wherein said portion of said identifying information comprises a unique report identifier and said study unique identifier corresponding to said study associated with said report.

10. A method of electronically packaging an object file relating to an electronic image file wherein the electronic image file includes identifying information uniquely identifying the image file, said method comprising the steps of:
obtaining the object file to be attached;
constructing a message with the object file attached to the message;
creating a header containing an attachment identifier including an object identifier identifying the type of object attached to the message and a unique identifier comprising a portion of the identifying information uniquely identifying the image file.

11. The method of claim 10 wherein said message is an email message, and further comprising the step of sending the message by way of SMTP.

12. The method of claim 10 wherein said object file comprises DICOM image file and wherein said identifying information comprises an image unique identifier, and wherein said portion of said identifying information comprises said image unique identifier.

13. The method of claim 10 wherein said object file comprises an overlay annotation file and wherein said identifying information comprises an image unique identifier corresponding to an image file associated with said overlay annotation file, and wherein said portion of said identifying information comprises a unique overlay file identifier and said image unique identifier corresponding to said image file associated with said overlay annotation file.

14. The method of claim 10 wherein said image forms at least in part a study, wherein said object file comprises a report associated with the study and wherein said identifying information comprises an study unique identifier corresponding to an study associated with said report, and wherein said portion of said identifying information comprises a unique report identifier and said study unique identifier corresponding to said study associated with said report.

15. A status message generator at a medical image viewer for generating a message containing status information concerning the viewing status of an object file relating to an electronic image file wherein the electronic image file includes identifying information uniquely identifying the image file, said status message generator comprising:
a message generator configured to generate a status message when an object file has been opened at the viewer,
said message generator comprising a header generator wherein said header generator is arranged to generate an object identifier identifying the type of object viewed and a unique identifier comprising a portion of the identifying information uniquely identifying the image file.

16. The status message generator of claim 15 wherein said object file comprises DICOM image file and wherein said identifying information comprises an image unique identifier, and wherein said portion of said identifying information comprises said image unique identifier.

17. A medical image viewing system comprising:
a remote viewer comprising:
an image receiver configured to receive from a central database through an interface, an electronic image file, wherein the image file includes image data and key information;
a relational database configured to store and relate the image data and the key information;
an extractor configured to extract key information from the image file and to store and relate the image data and the key information in the relational database;
an input device configured to input an attachment into said viewer, wherein the attachment is to be related to the image file; and
a packaging system arranged to package the attachment in a transmittable package for delivery from the remote viewer to the central database, so that the attachment may associated with the image file in the central database.

18. The medical image viewing system of claim 17 wherein said package includes said key information.

19. The medical image viewing system of claim 18 wherein said key information comprises a unique image identifier corresponding to the image file.

20. The medical image viewing system of claim 17 wherein the image file is at least a part of a study; and wherein said key information further comprises a unique study identifier corresponding to the study.

21. The medical image viewing system of claim 17 wherein said package is a formatted for secure transmission over a public communication system.

22. The medical image viewing system of claim 17 further comprising an attachment storer arranged to store the attachment so that the attachment is related in the relational database to the image file.

23. The medical image viewing system of claim 17 wherein said attachment is an overlay.

24. The medical image viewing system of claim 17 wherein said attachment is a text report.

25. The medical image viewing system of claim 18 wherein the package comprises an e-mail header and the attachment, wherein said header includes identifying information arranged to identify a type of attachment.

26. The medical image viewing system of claim 17 wherein the receiver is configured to receive the image file in a background process, said image receiver comprising a data requestor configured to request image files waiting to be sent by the central database.

27. The medical image viewing system of claim 17 wherein said extractor is configured to extract the key information from the image file and to store and relate the image data and the key information in the relational database in a background process.

28. A medical image viewing system comprising:
a remote viewer comprising:
an image receiver configured to receive through a remote interface, an electronic image file from a central data system, wherein the image file includes image data and key information, and wherein the receiver is configured to receive an image file in a background process;
a relational database configured to store and relate the image data and the key information;
an extractor configured to extract key information from the image file and to store and relate the image data and the key information in the relational database in a background process;
a display device in communication with the relational database; and a user input device coupled to said relational database and said display device, wherein said user input device is arranged to allow a user to select an image from the relational database in a foreground process, to display the image in a visible format at the display device; and
a status message generator configured to generate a status message when an image file has been opened with the user input device; and a sender configured to send a status message through a remote interface to the central data system, wherein said status message generator is configured to submit the status message to the sender.

29. The medical image viewing system of claim 28 wherein said status message generator operates in a background process.

30. The medical image viewing system of claim 28 further comprising an image file annotator configured to create an image annotation with user input at the user input device.

31. The medical image viewing system of claim 30 wherein said image file annotator operates in a foreground process.

32. The medical image viewing system of claim 30 wherein said annotation is an image overlay.

33. The medical image viewing system of claim 30 wherein said annotation is a text attachment.

34. The medical image viewing system of claim 28 wherein the viewer receiver further comprises a requestor configured to request the central data center to send the image file to the viewer receiver.

35. The medical image viewing system of claim 34 wherein the requestor is configured to request the central data system for image files upon the occurrence of a predetermined event.

36. The medical image viewing system of claim 35 wherein the predetermined event is the expiration of a predetermined time interval.

37. A central data system for a medical image management system comprising:
a receiver configured to receive an electronic medical image file including key information, from an electronic medical image file transmitter, the electronic medical image file transmitter being associated with an medical imaging device and being arranged to transmit an electronic image file including key information to a central data system,
a sender configured to transmit electronic image files through a remote interface to an image viewer;
a relational database arranged to store the key information associated with the electronic image files, said relational database including a tracking database,; and
an image storing and routing system operative to extract the key information from said image file, to store the key information in said relational database, and to submit the image file to the sender from which said image file is transmitted to a designated remote viewer,
wherein said receiver is configured to receive a status message from the image viewer corresponding to transmission status of the image, and wherein said tracking database is configured to store information related to transmission status of the image.

38. A central file system for a medical image management system comprising:
a receiver configured to receive an electronic medical image file of a study, from an electronic medical study transmitter, said image file including key information including information associating the image file with a unique study, the electronic medical image file transmitter being associated with an medical imaging device and being arranged to transmit the electronic image file including key information to a central data system,
a sender configured to transmit a unique study including an electronic image file through a remote interface to an image viewer;
a relational database arranged to store the key information associated with the electronic image file, said relational database including a tracking database arranged to track images transmitted from the sender; and
an image storing and routing system operative to extract the key information from said image file, to store the key information in said relational database, and to submit the image file to the sender from which said image file is transmitted to a designated remote viewer,
wherein said receiver is configured to receive a status message from the image viewer corresponding to viewing status of at least one image of said unique study, and wherein said tracking database is configured to store information related to viewing status of the image.

39. A medical image file management system comprising:
a central data system comprising a receiver configured to receive an electronic medical image file including key information, from an electronic medical image file transmitter, the electronic medical image file transmitter being associated with a medical imaging device and being arranged to transmit an electronic image file including key information to a central data system,
a sender configured to transmit electronic image files through a remote interface to an image viewer;
a relational database arranged to store the key information associated with the electronic image files; and
image storing and routing logic operative to extract said key information from said image file, to store said key information in said relational database, and to submit the image file to the sender from which said image file is transmitted to a designated remote viewer,
wherein the key information in the image file includes route information indicating a viewer to which the image file is to be routed, said central data system further comprising:
a verification system configured to verify allowance of a route contained in the route information contained with said image file before said sender transmits the file to a viewer.

40. The medical image file management system of claim 39 wherein the relational database comprises a file including legitimate addresses for a viewer, wherein the verification system is configured to verify existence of an address corresponding to the route information contained in the image file.

41. The medical image file management system of claim 39 wherein the relational database comprises a file including authorizations for a viewer to receive a file, wherein the verification system is configured to verify authorization of a viewer to receive the image file.

42. The image file management system of claim 39 further comprising an administrative access system configured to provide access to an administrator to said verification system to correct image files addresses that are not verified as legitimate by the verification system.

43. A medical image management system comprising:
a central data system comprising a receiver configured to receive an electronic medical image file including key information, from an electronic medical image file transmitter, the electronic medical image file transmitter being associated with an medical imaging device and being arranged to transmit an electronic image file including key information to a central data system,
a sender configured to transmit electronic image files through a remote interface to an image viewer;
a relational database arranged to store the key information associated with the electronic image files;
image storing and routing logic operative to extract said key information from said image file, to store said key information in said relational database, and to submit the image file to the sender from which said image file is transmitted to a designated remote viewer;
an image file archive; and
an archiving system configured to archive the image file in the image file archiver.

44. The medical image file management system of claim 43 wherein the archiver comprises a lifetime storage system.

45. A system for packaging an electronic medical image file for secure transmission, wherein the electronic image file includes key information concerning the image file, comprising:
a message generator configured to generate a message having a header, wherein said header identifies a type of image file to be attached to the message, said message generator further being configured to attach the image file as an attachment to the message;
a transmitter for transmitting the message in a secure transmission format.

46. The system of claim 45 wherein said message generator comprises an e-mail generator.

47. The system of claim 45 wherein said secure transmission format is SSL.

48. A system for lifetime storage of image files accessible by way of a public communication system, comprising:
a data center comprising a receiver configured to receive an electronic medical image file including key information, from an electronic medical image file transmitter, the electronic medical image file transmitter being associated with an medical imaging device and being arranged to transmit an electronic image file including key information to a central data system,
a sender configured to transmit electronic image files through a remote interface to an image viewer;
a relational database arranged to store the key information associated with the electronic image files; and
image storing and routing system operative to extract said key information from said image file, to store said key information in said relational database, and to submit the image file to the sender from which said image file is transmitted to a designated remote viewer
an archive arranged to store the image file on a tape system.

49. The system of claim 48 wherein the tape system stores the image file according to the imaging center of the image file origin.

50. The system of claim 49 wherein the tape system stores the image file according to imaging modality.
